(19) United States
(12) Patent Application Publication
(10) Pub. No.: US 2005/0075949 A1
(43) Pub. Date: Apr. 7, 2005

(54) Method and system for analyzing and planning an inventory

(76) Inventors: Thomas C. Uhrig, Indianapolis, IN (US); Robert J. Zigon, Indianapolis, IN (US); Larry R. Myers, Greenfield, IN (US); Ryan J. Mitchell, Brownsburg, IN (US)

Correspondence Address: BOSE MCKINNEY & EVANS LLP, 135 N PENNSYLVANIA ST, SUITE 2700, INDIANAPOLIS, IN, 46204, US

(21) Appl. No.: 09/805,720

(22) Filed: Mar. 8, 2001

Related U.S. Application Data
(60) Provisional application No. 60/258,914, filed on Dec. 29, 2000.

(51) Int. Cl. G06F 17/60

(52) U.S. Cl. 705/28

(57) ABSTRACT

A method for analyzing and planning an inventory according to a business objective using computer software is provided, wherein the inventory has related inventory data stored in a computer memory. The method includes the steps of analyzing the inventory data to identity a characteristic of the data configuring via a user interface a plurality of rules for generating a stocking plan in accordance with the business objective and the characteristic, generating the stocking plan, and evaluating the stocking plan in relation to the business objective.

This application claims the benefit of provisional application Ser. No. 60/258,914, filed Dec. 29, 2000, which is hereby incorporated herein by reference.

### TECHNICAL FIELD

The present invention relates to computer software systems for analyzing and planning inventory.

### BACKGROUND AND SUMMARY

One perplexing problem for inventory managers is to minimize inventory costs while continuing to support the service levels customers expect. In particular, maintaining expected service levels is critical to the success of any supply business. A major challenge is to plan an inventory to meet these service levels, or other business objectives, at the lowest cost. Another significant challenge is to adapt the inventory plan as the inventory changes.

A multitude of computer systems address the problem of inventory management. Basic concepts of inventory management are described in chapter 10 of Strategic Logistics Management, 2nd Ed. (Irwin, Inc. 1987), hereby incorporated herein by reference. Enterprise systems, such as order management systems, distribution systems, and manufacturing systems, perform order processing, purchasing, and inventory management functions. Systems such as those currently known in the art as Enterprise Resource Planning (ERP), Manufacturing Resource Planning (MRP) and Distribution Resource Planning (DRP) systems also manage inventory data and transactions related to inventory. Decision support systems assist executive-level decision makers with strategic decisions relating to business planning and budgeting.

Several current business trends indicate that there is a need for inventory analysis and planning software that is capable of generating more complex and refined stocking plans that are specifically tailored to the particular characteristics of a given inventory, and producing these stocking plans more quickly. These trends include: (i) an increased appreciation for the magnitude of cost savings available through inventory analysis and planning; (ii) the consolidation of distribution operations, resulting in large inventories too complex for conventional inventory planning systems; (iii) an increasing customer demand for product availability service level agreements (and consequently, the need for distributors to know the cost of achieving these service levels); (iv) widespread implementations of ERP systems, which provide integrated data and help accomplish inventory analysis and planning quickly and inexpensively; (v) an increased focus on the supply chain as a source for achieving cost reductions; and (vi) the decreasing cost of implementing an inventory planning system.

The present invention is directed to a method and system for inventory analysis and planning that is responsive to these needs. The benefits of the system of the present invention include: the ability to quickly adapt stocking plans to changes in the inventory, the ability to interactively create and compare the results of multiple stocking plans and change the way inventory data is analyzed “on the fly,” and the ability to access the system via a global communications network, such as the Internet.

Accordingly, the present invention includes a method for analyzing and planning an inventory according to a business objective using computer software, the inventory having related inventory data stored in a computer memory, the method comprising the steps of analyzing the inventory data to identify a characteristic of the data, configuring via a user interface a plurality of rules for generating a stocking plan in accordance with the business objective and the characteristic, generating the stocking plan using the plurality of rules, and evaluating the stocking plan in relation to the business objective.

The present invention further includes a method for analyzing and planning an inventory according to a business objective using computer software, the inventory having related inventory data stored in a computer memory, the method comprising the steps of selecting via a user interface a first group of the inventory data according to a first criterion, generating a first stocking plan using the first group of the inventory data, selecting via the user interface a second group of the inventory data according to a second criterion, generating a second stocking plan using the second group of the inventory data, and selecting one of the first stocking plan and the second stocking plan in accordance with the business objective.

The present invention further includes a method for analyzing and planning an inventory in accordance with at least one business objective using computer software, the inventory having related inventory data and a plurality of rules stored in a computer memory, the method comprising, generating a plurality of stocking plans based on the inventory data and the plurality of rules, and selecting an optimum stocking plan from the plurality of stocking plans based on the at least one business objective.

The present invention further includes a method for analyzing and planning an inventory according to a business objective using computer software, the inventory having related inventory data stored in a computer memory, the method comprising the steps of performing via a user interface a plurality of steps, the plurality of steps including selecting a business objective, selecting a group of the inventory data based on a predetermined criterion, selecting a method of generating the stocking plan, selecting at least one rule for generating the stocking plan, and configuring the at least one rule for generating the stocking plan, executing the selected method using the selected business objective, the selected group of data and the selected rules to generate a first stocking plan, changing via the user interface one of the selected method, business objective, group of data, and rules, generating a second stocking plan, and selecting one of the first stocking plan and the second stocking plan in accordance with the business objective.

The present invention further includes a method for generating a stocking plan for an inventory in accordance with at least one business objective using computer software, the inventory having related inventory data, the method comprising the steps of receiving the inventory data from at least one remote data source, storing the inventory data in a computer memory, defining a plurality of rules based on the inventory data and the at least one business objective, the plurality of rules comprising at least one rule related to a business environment of the inventory, at least one rule related to the inventory, at least one rule related to a demand for the inventory, at least one rule related to a supplier of the inventory, and generating a stocking plan in accordance with the plurality of rules.

The present invention further includes a method for analyzing and planning an inventory to meet at least one overall business objective, the inventory having inventory data, a plurality of rules, and at least one stocking plan related to the overall objective, the inventory data, plurality of rules, and at least one stocking plan stored on a main computer coupled to a global communications network, the method comprising the steps of accessing one of the inventory data, the plurality of rules and the stocking plan on the main computer from a remote computer, reviewing via a web browser on the remote computer the one of the inventory data, the plurality of rules, and the stocking plan, creating via the web browser a message relating to the one of the inventory data, the plurality of rules, and the stocking plan, and transmitting the message from the remote computer to the main computer.

The present invention further includes a method for storing inventory data for use in a computer system for inventory analysis and planning, the method comprising the steps of receiving inventory data from a remote data source, grouping the inventory data according to business, inventory, demand and supply criteria, and storing the grouped data in a computer memory.

The present invention further includes a method for analyzing inventory data in accordance with a preselected business objective to generate a stocking plan for an inventory using computer software, the method comprising the steps of creating a plurality of solution paths, wherein each solution path comprises a subset of the inventory data, a first plurality of rules for analyzing the subset of the inventory data, and a second plurality of rules for generating the stocking plan, testing the plurality of solution paths on the subset of the inventory data by generating a plurality of stocking plans, comparing the plurality of stocking plans to the preselected objective; and storing a solution path that generated an optimum stocking plan relative to the preselected objective.

These and other features, aspects, and advantages of the present invention will become better understood with regard to the following description, claims, and accompanying drawings.

### BRIEF DESCRIPTION OF THE DRAWINGS

FIG. 1 shows a summary flow diagram of an illustrated embodiment of the present invention.

FIG. 2 shows a flow diagram of the receive data process of an illustrated embodiment.

FIG. 3 shows a flow diagram of the analyze data process of an illustrated embodiment.

FIG. 4 shows a flow diagram of the configure rules process of an illustrated embodiment.

FIG. 5 shows a flow diagram of the generate stocking plan process of an illustrated embodiment.

FIG. 6 shows a flow diagram of the evaluate stocking plan process of an illustrated embodiment.

FIG. 7 shows a flow diagram of the export process of an illustrated embodiment.

FIG. 8 shows a system block diagram for an illustrated embodiment of the present invention.

FIGS. 9-27 show user interfaces for illustrated embodiments of the present invention.

FIGS. 28-32 show data structures for an illustrated embodiment of the present invention.

### DETAILED DESCRIPTION OF THE DRAWINGS

The method and system for analyzing and planning an inventory in accordance with the present invention operates to analyze and plan inventory to meet selected business objectives. The method and system of the present invention is described in greater detail with reference to the embodiments illustrated in the accompanying drawings.

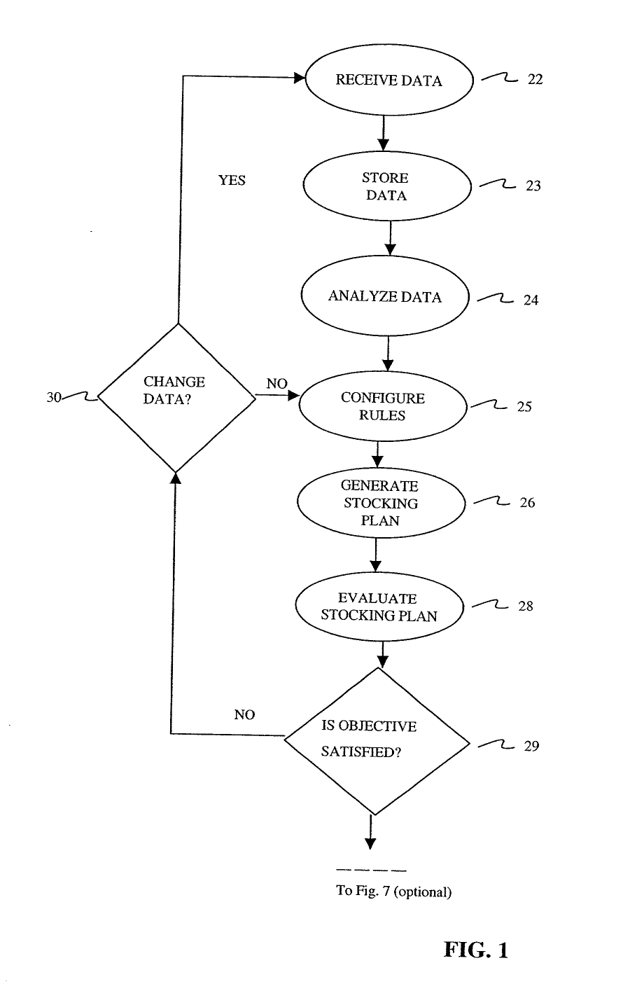

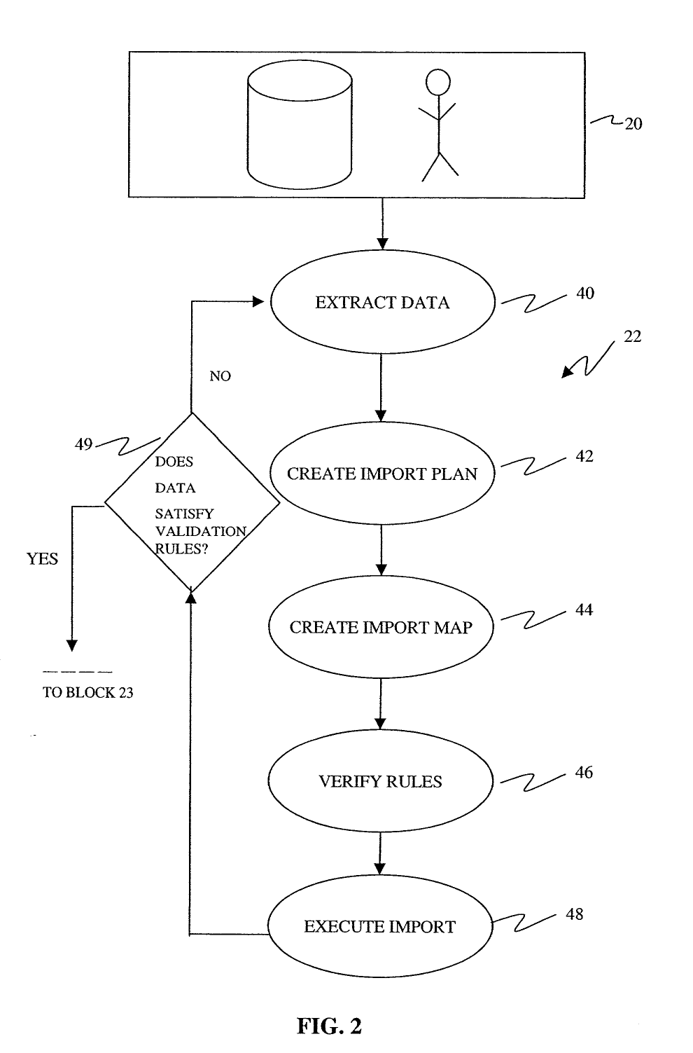

FIG. 1 shows an overview flow diagram of the operation of an illustrated embodiment of the present invention. Inventory data is received from a plurality of data sources 20 (shown in FIG. 2) at block 22. At block 23, the extracted data is stored in a computer memory. The stored inventory data is analyzed by one or more end users using a user interface at block 24. At block 25, end users select and configure rules to be used to generate a stocking plan. At block 26, the generate stocking plan process executes the commercially available LogicSTOCK™ software, available from TCLogic, LLC, of 429 North Pennsylvania Street, Indianapolis, Ind. to run inventory optimization calculations on the stored inventory data using the rules configured at block 25.

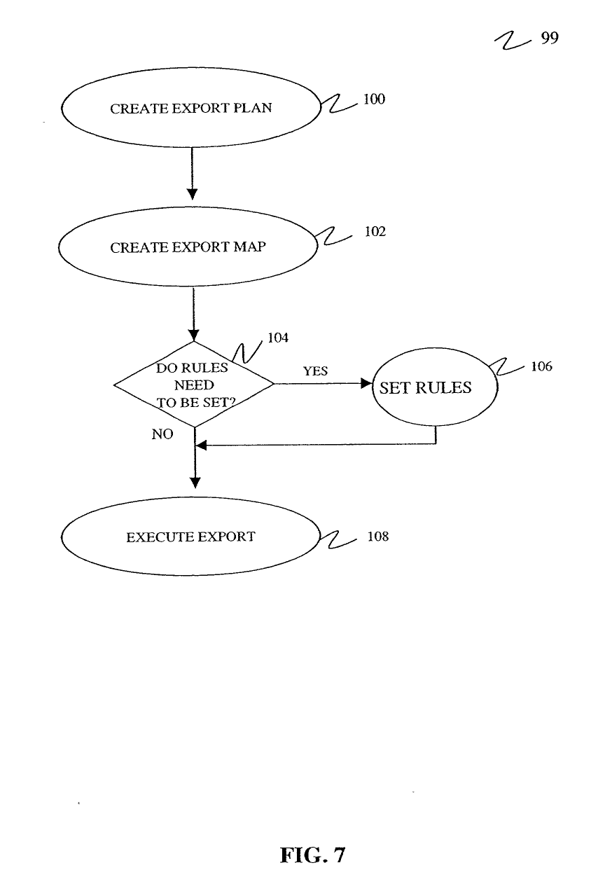

At block 28, the stocking plan is evaluated in accordance with one or more business objectives. At block 29, a decision is made as to whether the stocking plan satisfies the objectives. If the stocking plan does not satisfy the business objectives, or is not feasible to implement, one or more of the processes at blocks 22-23, 24, 25, 26, and 28 are repeated. If the stocking plan is satisfactory, export process 99 (shown in FIG. 7) may optionally be executed to make the stocking plan information available to other computer systems or software applications. At block 30, an end user decides whether to change the inventory data being analyzed and used to generate the stocking plan. If the end user decides to change the data, the receive data process of block 22 and the store data process of block 23 are repeated. Each of blocks 22-26, 28-29 and 30 are described in more detail below.

### I. RECEIVING THE INVENTORY DATA

FIG. 2 shows in more detail the specific processes involved in the receive data process of block 22. The inventory data used by the illustrated embodiments is obtained from one or more data sources 20. Each of the data sources 20 may be a flat file, a database, a spreadsheet, a paper document, a person, or other type of data source. Preferably, a data source 20 is an enterprise resource planning (ERP) system or similar transaction processing system having a relational database.

Inventory data is extracted from data sources 20 by the extract data process at block 40. There are multiple options for extracting and importing data that are well known in the computer programming art. In the illustrated embodiment, the inventory data is exported from an ERP system to a flat file. An import plan is created by the create import plan process at block 42. The create import plan process executed at block 42 identifies the data source(s) for the inventory data and the type and location of the data source. This information is included in the import plan. For example, the data source is a file and the file type and location are identified in the import plan.

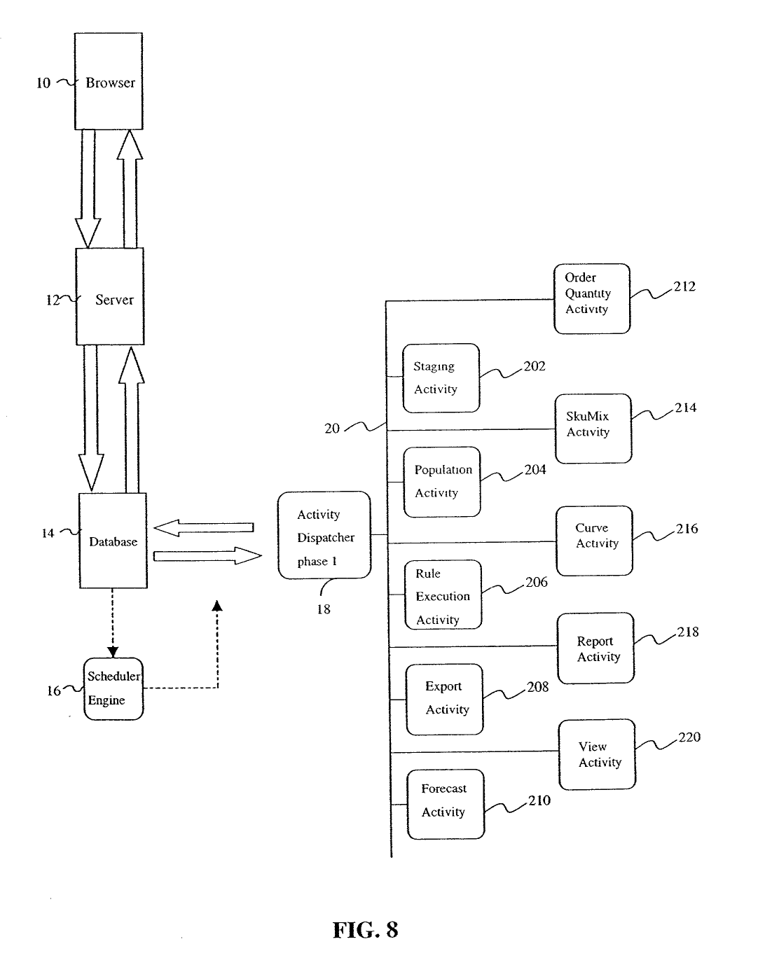

At block 44, the create import map process identifies the data that is to be imported from the data source and the resident location for that data in the database 14 (shown in FIG. 8). Optionally, user defined fields (UDFs) are created. Data is imported data into a UDF when information needs to be imported that does not have a pre-defined location in the database 14. Data identified in the import map includes inventory item identifying information (e.g., Stock Keeping Unit or SKU) and the physical location of each item in the inventory. Demand and strategy data are also identified in the import map. The demand data includes usage history for inventory items and future demand predictions for those items, as calculated using probability and statistics algorithms known in the art. Strategy data includes ordering and stocking data for inventory items and typically includes UDF fields in order to accurately represent the stocking logic for each item.

At block 46, import data validation rules for each data source are verified to make sure they are set correctly for each data source. Examples of data source properties include the definition of the time period covered by the imported data (e.g., monthly, quarterly, etc.), forecast periods, and graph parameters. Rules pertaining to the execute import process of block 48 are verified and rule parameters are set at block 46. For example, validation error parameters are set for cost, lead time, and forecast data, so that if the imported data is outside a predefined valid range, an error occurs. If an error occurs, either the rule is modified or the data is reimported.

At block 48, the execute import process is executed. Data is transferred from the data source(s) 20 to a temporary storage area, such as staging tables in a relational database. Validation rules are executed against the data to determine if the data is sufficient to enable stocking plans to be generated. A rule is a computer programming term known in the art that refers to a piece of programming code which instructs a computer how to react to the occurrence of a specific condition. For example, if an inventory item does not have a demand forecast associated with it, the item is flagged to indicate to the end user that more data is needed. For imported inventory data that is related to a time series (such as forecasts or cost data), the data is tested using a statistical time series analysis. If the imported data for a particular item appears wrong or inconsistent with the expected pattern for the item, the data is flagged to indicate to the end user that it needs to be verified.

If the data is incomplete or the quality of the data is insufficient, a decision is made at block 49 to repeat the aforementioned processes 40, 42, 44, 46, and 48. If the validation rules indicate that the data is sufficient, then the inventory data is transferred from the temporary storage area to the appropriate tables of database 14 according to the import map created at block 44.

### II. STORING THE INVENTORY DATA

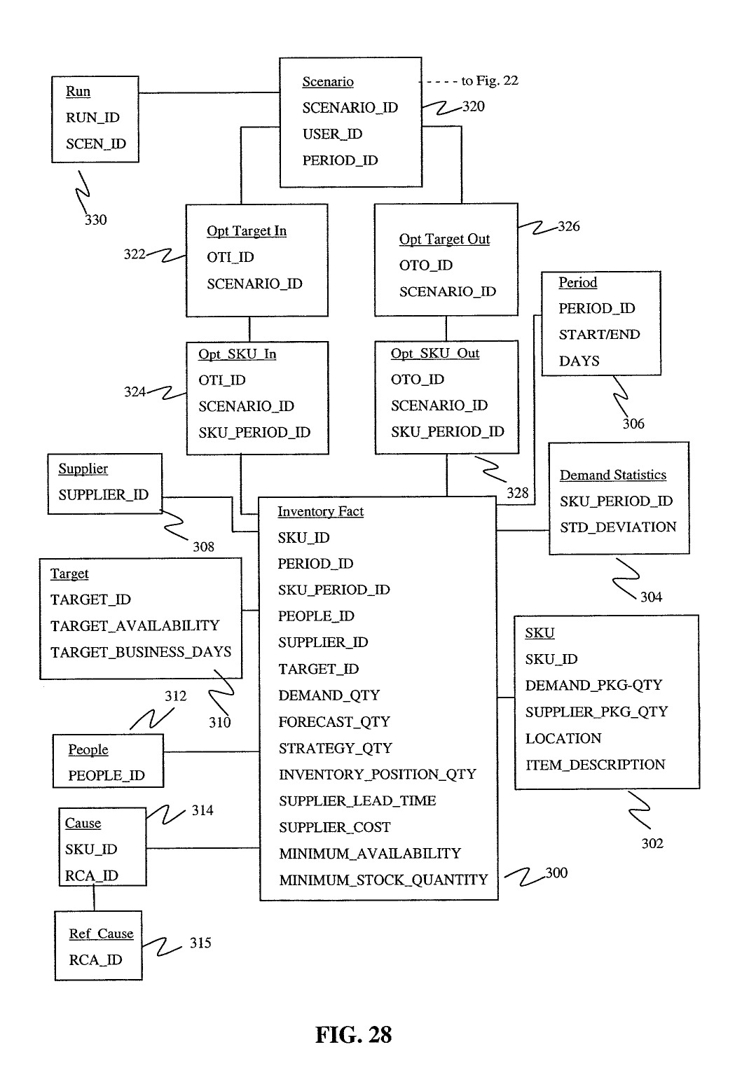

At block 23, the received inventory data is stored in database 14, shown in FIG. 8. In the illustrated embodiment, data is organized and stored according to multiple interlocking “star” schema currently known in the art as a “constellation,” as shown in FIGS. 28-32. These concepts, known to persons skilled in the data warehousing art, are discussed in The Data Warehouse Toolkit, by Ralph Kimball (John Wiley & Sons, Inc., 1996), particularly at pp. 1-116, 143-152, 161-230 and 243-278, which are hereby incorporated herein by reference.

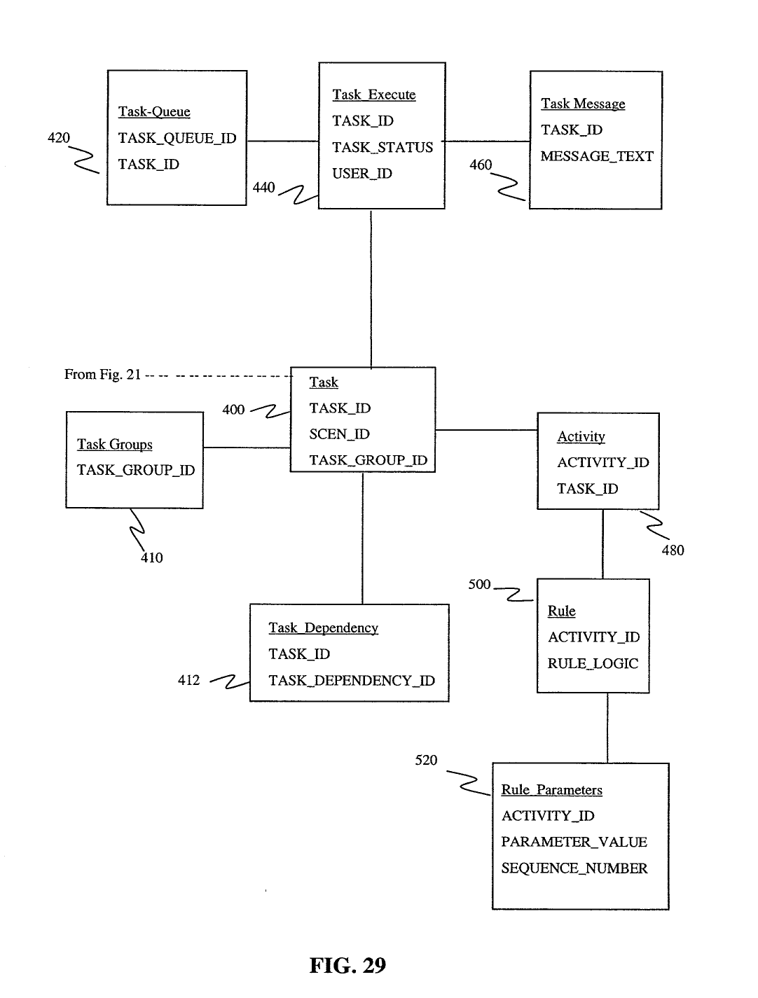

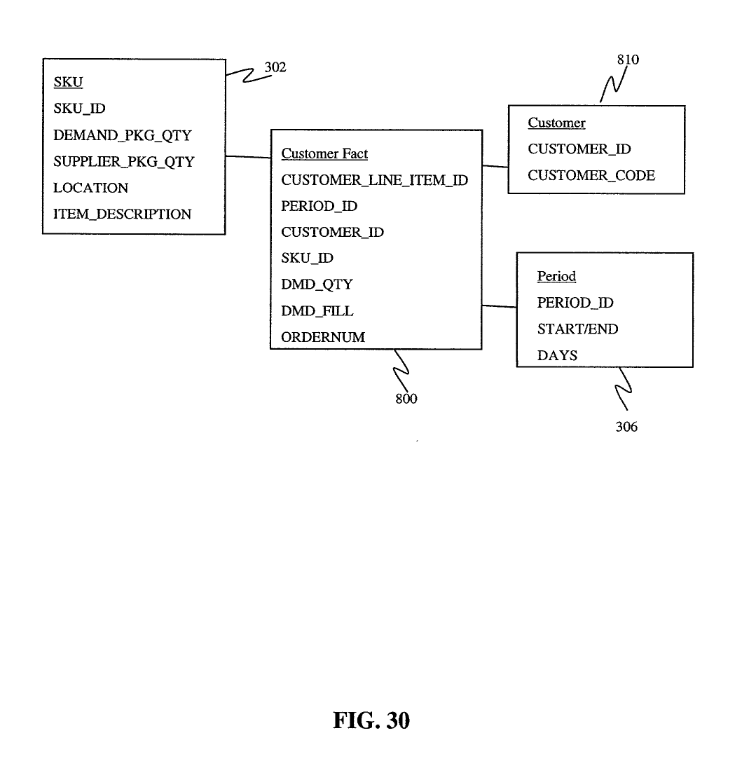

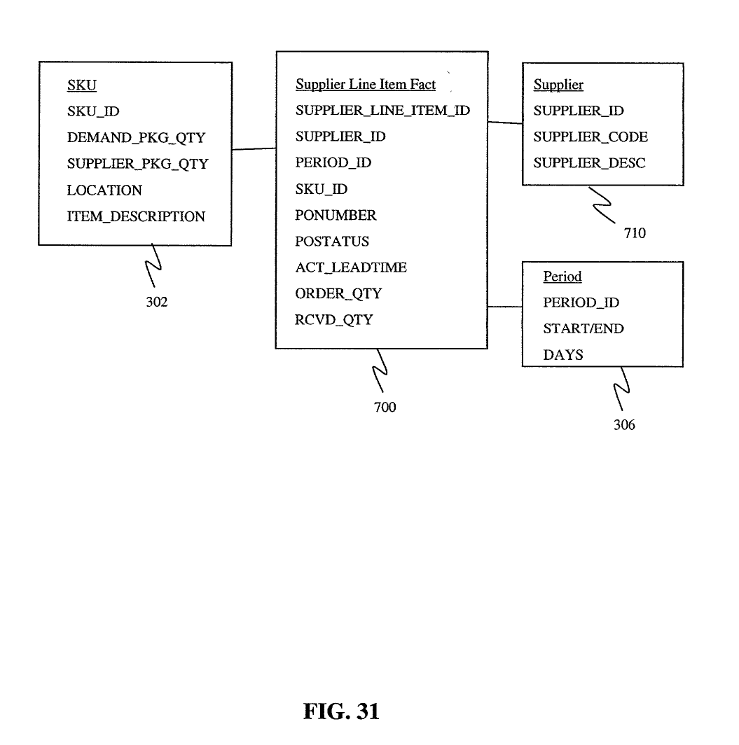

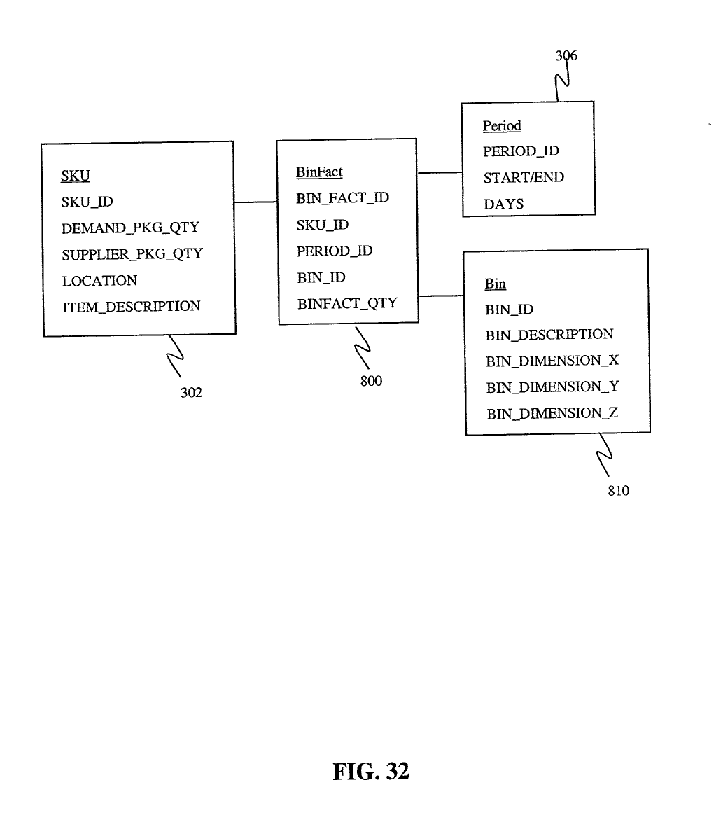

Database 14 comprises a plurality of interrelated tables in a database system. Commercially available database systems may be used to implement the data structures of this embodiment. One such currently commercially available system is Microsoft SQL Server. In the embodiment illustrated in FIGS. 28-32, database 14 comprises a plurality of star schema including an inventory star (FIGS. 28-29), a customer star (FIG. 30), a), a supplier star (FIG. 31), and a bin star (FIG. 32).

FIG. 28 shows the inventory star schema of database 14, which stores data related to items in the inventory. The inventory star includes an inventory fact table 300, which is used to store demand, forecast, strategy, inventory quantity, and supply data for a particular inventory. The inventory data is preferably organized according to time period, e.g., month, quarter, year.

Demand data stored in the inventory fact table 300 includes historical customer demand data illustratively received from an ERP system, and includes demand fill quantity (the quantity of customer orders actually filled), demand quantity (the total quantity ordered by customers), demand adjusted quantity (a demand quantity value adjusted by an inventory planner); similar data for line items (which line items are actual lines on a customer order, comprising a SKU plus the ordered quantity, whereas a SKU comprises an item and a stocking location); and a demand service level (the service level at which the demand for a SKU was met during the period).

Forecast data stored in the inventory fact table 300 may be received from an external data source, such as an ERP system, or may be generated by forecasting modules included in the system of the present invention. The forecast data includes a forecast quantity (the predicted demand quantity for a future time period, as generated by forecasting algorithms), and adjusted forecast quantity (as adjusted by an inventory planner) and similar forecast data for line items.

Strategy data included in the inventory fact table 300 is data that relates to the business objectives. Strategy data is either obtained from an external data source, such as an ERP system, or is set by the inventory planner who is responsible for managing the SKU. Strategy data includes, for example, minimum stocking quantity (a minimum quantity of an item that must be kept on hand), minimum availability (the minimum availability level for an item), minimum safety stock quantity, margin price, non-stock cost, usage probability, safety stock quantity, and cycle stock quantity.

Inventory data related to the current inventory position is stored in the inventory fact table 300 includes data that describes the current status of the inventory, such as quantity on order, work in progress quantity, on hand quantity, back order quantity, available quantity, and allocated quantity. In the illustrated embodiment, inventory position data is primarily stored for the purpose of generating reports and views that enable end users to compare the current inventory position to the optimized position.

Supplier data stored in the inventory fact table 300 includes supplier average lead time (the average lead time a supplier needs to fill an order), and supplier cost. Supplier data is generally used to assist inventory planners with determining how to replenish items that are being stocked.

A plurality of tables, which are known as “dimensions” in the current terminology of the data warehousing art, are linked to the inventory fact table, including SKU 302, demand statistic table 304, period table 306, supplier table 308, target table 310, people table 312, and cause tables 314-315. The inventory fact table 300 includes unique identifiers that enable it to be linked to each of the dimension tables; for example, period ID, SKU ID, people ID, supplier ID, and target ID.

SKU table 302 is linked to the inventory fact table 300 through a unique SKU identifier. In the illustrated embodiment, each unique SKU is associated with an infinite number of records in the inventory fact table, but each inventory fact is associated with one SKU. SKU table 302 generally stores non-additive information about the SKU, such as item description, item family, item business unit, location description, demand package quantities, supply package quantities, and other relatively static characteristics of a SKU such as height, weight, length and depth of individual SKU items.

SKU table 302 also stores multiple types of location, demand, and supply data. For example, location data may include a particular warehouse, geographic or region. Demand package quantity, the quantity of a SKU as sold to customers, can be tracked at the package, pallet row, pallet, or truck level. Supply package quantity, the quantity of a SKU as received from the supplier, may also be tracked by the quantity per package, pallet row, pallet or truck. Another piece of information that may be tracked by SKU table 302 is whether the SKU belongs to a kit; in other words, whether the item is a part of a larger assembled product.

Demand statistics table 304 is linked to the inventory fact table 300 via the SKU period unique identifier. Demand statistics table 304 stores demand statistics for an item over a time period. Demand statistics are obtained from an external data source or are calculated when a rule for calculating demand statistics is run. Demand statistics data is needed to run the generate stocking plan process of block 26. In the illustrated embodiment, each inventory fact instance is associated with one instance of demand statistics for a given time period.

Period table 306 is a dimension table linked to the inventory fact table 300 via the period ID unique identifier. Period table 306 stores information to define a particular time period for analysis of the inventory data, including a period start date, end date, and number of days. In the illustrated embodiment, each inventory fact record is associated with one period, but a given period is capable of being associated with an infinite number of inventory facts.

The supplier dimension table 308 is linked to the inventory fact table 300 via a unique supplier identifier. Supplier table 308 includes a code and description for a supplier of inventory. In the illustrated embodiment, each instance of an inventory fact is associated with one supplier, but each supplier is capable of being associated with an infinite number of inventory facts.

Target table 310 stores information regarding the business objectives and other information needed by the generate stocking plan process of block 26, for example, the target availability or target cost of meeting a certain availability level. Flags are stored in target table 310, for example, to indicate whether to use package quantity or to perform optimization factoring when calculating availability. In the illustrated embodiment, each inventory fact is associated with only one instance of target data. Target table 310 is linked to the inventory fact table 300 via the target ID unique identifier.

The people dimension table 312 stores information related to an end user designated as the inventory planner, such as the planner's description and other people in the planner's organization. People table 312 is linked to the inventory fact table 300 via the people ID unique identifier. In the illustrated embodiment, each instance of an inventory fact is associated with only one people ID.

Cause dimension tables 314 and 315 are used to enable the collaboration process 92. Cause table 314 is linked to the inventory fact table 300 via the SKU ID unique identifier. In the illustrated embodiment, each inventory fact instance is capable of being associated with many instances of cause table 314, but each instance of cause table 314 is associated with only one inventory fact. Cause table 314 stores information submitted by end users during collaboration step 92.

Reference cause table 315 is linked to cause table 314 via a unique reference cause identifier, and enables comments created during collaboration step 92 to be assigned to a particular category. Comments on a particular SKU are grouped according to category in the illustrated embodiment.

Also shown in FIG. 28, the inventory fact table 300 is linked to intermediate tables optimized SKU in 324 and optimized SKU out 328 by the SKU period unique identifier. Optimized SKU in table 324 is linked to optimized target in table 322 via a unique identifier comprising a unique scenario id and a unique optimized target In identifier. Optimized SKU in 324 and optimized target in 322 are staging tables that hold SKU and target data needed by the generate stocking plan process of block 26.

Optimized SKU out table 328 is linked to optimized target out table 326 via a unique scenario ID and a unique optimized target out identifier. Optimized SKU out 328 and optimized target out 326 are staging tables that hold SKU and target data that has been generated during the generate stocking plan process of block 26.

The “optimized SKU” tables 322, 324, 326, and 328 allow the generate stocking plan process of block 26 to run independently of the rest of database 14. A stocking plan is stored in the “optimized out” tables 326 and 328 while a determination is being made as to whether the stocking plan is feasible to implement. Tables 322, 324, 326 and 328 allow multiple stocking plans to be generated with varying rules and parameters. Reports and views can be generated to analyze and compare the stocking plans to one another and the current inventory position. If an authorized end user approves a stocking plan, data about the approved stocking plan is transferred from the optimized out tables 326 and 328 to the inventory fact table 300 of database 14.

Scenario table 320 holds information that tracks the status of database 14, as well as activities and tests that have been run against it. Scenario table 320 is linked to run table 330. Run table 330 stores data to allow scenarios to be scheduled to run at some time in the future.

A scenario is a series of tasks or processes that are performed on a copy of database 14 by an end user during a specified time period. Data about scenarios, including a user id and a time period id, is stored in scenario table 320, shown in FIG. 28. Scenario table 320 is linked to the information in the optimize SKU tables 322-328 via the scenario ID unique identifier to associate an end user with a period of inventory data.

Task data is stored in task table 400, shown in FIG. 29. Task table 400 is linked to scenario table 320 via the scenario ID to associate an end user with one or more tasks, which are a series of activities driven by rules that are performed on the inventory data that is associated with the end user through scenario table 320. In the illustrated embodiment, a task can be associated with only one scenario, but a scenario can include one or more tasks. Task table 400 stores information such as a task description, user interface order, and whether the task is a “built-in” task that is part of the base system of the present invention or is a task created at the request of an end user.

Individual tasks are grouped according to the logical activities of the end user, by defining task groups in task groups table 410, as shown in FIG. 29. For example, tasks relating to analyze current situation step 24 may be associated with a common task group id. Task dependency table 412 is used to store data indicative of whether a particular task is dependent upon completion of another task.

Task queue table 420, task execute table 440, and task message table 460 store data to enable the various tasks to be executed. Task queue table 420 is monitored by the activity dispatcher software program 18 for the occurrence of new tasks. When data for a new task appears in the task queue 420, the activity dispatcher 18 causes the necessary procedures to run to execute the task. Task execute table 440 tracks information concerning the status of the task execution, e.g., whether the task is pending, executing, or finished. Task message table 460 stores message information resulting from execution of a task, such as error messages.

A task includes one or more activities. Activities are individual operations performed on database 14. Activity data is stored in activity table, shown in FIG. 29. A task can have an infinite number of activities but each activity can only have one task associated with it. Information stored in activity table 480 includes a description of the activity, dependency information, the type of activity, and whether the activity is “built-in” or specific to a particular end-user. The activity type information corresponds to the name of the particular activity engine that is invoked to execute that activity. For example, an activity type of “staging” corresponds to staging activity engine 202, shown in FIG. 8. The staging activity engine 202 is a standalone procedure that performs the transfer of data from an external data source to a temporary staging area within database 14.

Other examples of activity engines, shown in FIG. 8, include populate activity 204 (transfers inventory data from the temporary staging area to the inventory star in database 14); rule execution activity (executes the specified rule on database 14 with the specified parameter values); export activity 208 (performs all or a portion of export process 99); forecast activity 210 (generates a demand forecast for a SKU and a given time period); order quantity activity 212 (performs analysis on the inventory data to determine how and/or when the stock of SKUs should be replenished); SkuMix activity 214 (performs generate stocking plan 26); curve activity 216 (generates the cost/availability tradeoff curve up to and beyond the desired availability level); report activity 218 (generates detail or summary reports, as requested by the end user); and view activity 220 (generates ad hoc views of the data in database 14 at the request of an end user).

Each activity for which information is stored in activity table 480 has rules and rule parameters associated with it. Rules are stored in rules table 500 and rule parameters are stored in rule parameter table 520, which are both linked to activity table 480 via a unique activity ID, as shown in FIG. 29. When an activity is selected to be included in a scenario or run, the appropriate activity engine accesses the activity table 480, rule table 500 and rule parameter table 520. The activity engine executes the rules related to the selected activity to perform logic using portions of database 14, and then updates the portions of database 14 that are affected by execution of the rule. Rules are illustratively implemented using structured query language (SQL) statements or as stored procedures. Systems consistent with the present invention enable end users to create rules that are specific to their particular business environment.

As shown in FIGS. 30-32, the “constellation” of the illustrated embodiment of database 14 also includes a customer star (FIG. 30) a supplier star (FIG. 31) and a bin star (FIG. 32).

Customer star, shown in FIG. 30, has a customer line item fact table 800. Dimension tables SKU 302 and period 306 are the same dimension tables that are linked to the inventory fact table 300. Customer dimension table 810 includes relatively fixed data about a particular customer or end user. The customer star of FIG. 30 is used to store line item data about a customer's demand for a particular SKU. Because the data is received from an external data source in order line format, it is aggregated during the execute import process of block 48 before it is stored in the inventory fact table 100.

As shown in FIG. 31, the supplier star includes supplier fact table 700, SKU 302, period 306 and supplier 710. The supplier star holds order line information relating to items received from a supplier. Since the information is received from external data sources in order line format, it is aggregated and processed during the execute import process of block 48 before it is stored in the inventory star of FIG. 28. For example, the data is processed to determine the average supplier lead time for a SKU in a given time period, and then only the supplier lead time information is stored in inventory fact table 300.

The bin star schema, shown in FIG. 32, includes information related to “bins,” e.g., locations in a warehouse, using bin fact table 800, SKU table 302, period table 306, and bin table 810. Bin data is processed and preferably only the portions of the bin data required to perform the algorithms for optimizing the use of space in a warehouse are stored in the inventory fact table 300.

### III. ANALYZING THE INVENTORY DATA

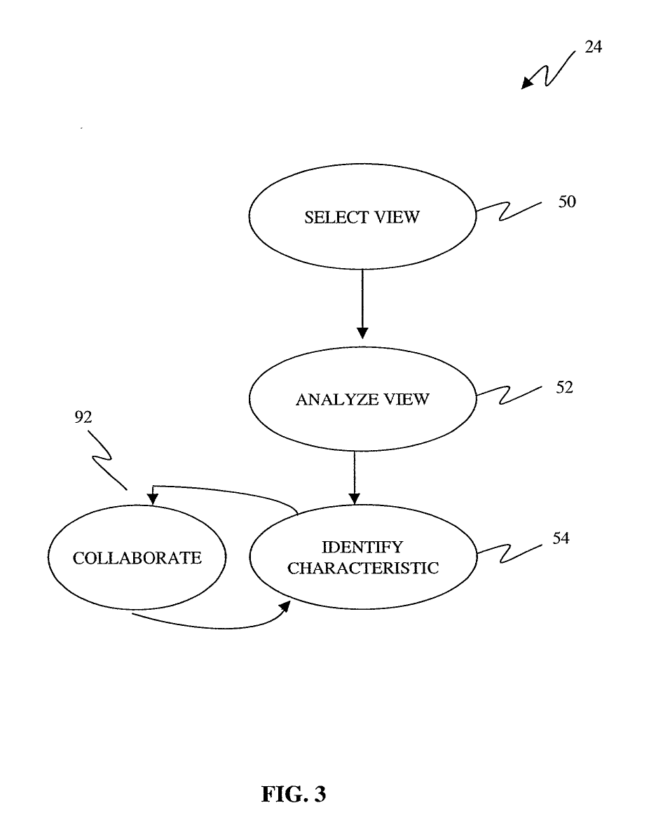

FIG. 3 illustrates a flow diagram of the analyze data process of block 24. At block 50, the end user selects a view of the data to analyze. Views are displays of the inventory data that are generated in response to a question that is asked about the data, e.g., a query. Views are generated by the execution of rules. The rules used by the analyze data process of block 24 can be configured and selectively enabled and disabled similar to the rules used by the generate stocking plan process of block 26 (discussed below).

In the illustrated embodiment, views include those known in the art as drill downs and summary views, where the data is sorted by multiple fields or characteristics. Views are generated using data mining techniques and other query tools to enable the end user to discover classifications (hereinafter referred to as “characteristics”) of the data. Characteristics of the data are descriptions of classes or groups of the data, where the data in the group has a common piece of information or attribute. For example, students having a Master of Science, Juris Doctor, or Ph.D degree are all graduate students, so one characteristic of this student data is that it pertains to “graduate students.”

Specific data mining techniques used in the illustrated embodiment, including data generalization using data cubes or attribute-oriented induction, and analytical characterization using attribute relevance analysis, are known in the art and described in Data Mining: Concepts and Techniques, by Han and Kamber (Morgan Kauffman Publishers, 2000), at pp. 179-224, hereby incorporated herein by reference.

At block 52, the end user analyzes the display of the inventory data created by the view selected at block 50. For example, a view of the inventory data could reveal that a particular item in an inventory is an emergency item or a slow moving item. How the item is characterized, e.g., whether the item is slow moving or not, is determined based on the particular business environment of the item or inventory. For example, for one customer, a slow-moving item may be an item that is sold only every 60 days, but for another customer, slow moving items are items that are sold only every 120 days. Based on the user's analysis, characteristics of the inventory data are identified at block 54. In order to help identify characteristics that have a significant impact on the stocking plan, the end user may execute the collaborate process of block 92 (discussed below).

Systems consistent with the present invention organize the end user's analysis of the inventory data according to business environment, inventory, demand and supply criteria to enable a broad range of inventory information to be included in the analysis and stocking plan generation.

Examples of information related to a business environment include a company's overall mission, financial objectives, marketing strategy, support infrastructure, overall service level, inventory turns, supply chain, demand channel, and internal efficiency. Inventory information pertains to the inventory or specific items in the inventory. An example of inventory information is whether particular customers consider an item to be critical, meaning that it has to be available on hand at all times. Demand information is used to help determine the inventory level required to meet anticipated customer demand for an item or a group of items. For example, a characteristic of an inventory demand is whether a particular item has a previous demand history. Demand forecast information is used to adjust stocking plans for seasonal changes in demand and other demand spikes. Supply information includes information about suppliers of inventory. For example, manufacturing lead time, order policies, and order multiples are supply-related factors that could impact the stocking plan.

The end user optionally executes one or more reports and charts to analyze the inventory data. Example reports and charts available in the illustrated embodiment include summary reports, detailed reports, item detail reports, comparison charts, custom reports, and other charts. Summary reports include reports comparing (i) the current inventory to the projected on hand inventory; (ii) current inventory strategy to the projected inventory strategy; (iii) the current inventory position; and (iv) economic order quantity. The data in summary reports can be grouped by cost, item, unit, or other selected criteria. Detailed reports showing information at the SKU level are also included in the illustrated embodiment.

Example charts included in the illustrated embodiment: item summary charts for on-hand inventory, cost of sales, availability, forecast, or new strategy; stocking strategy; forecast accuracy; and a comparison of forecast versus actual availability for the given set of parameters, by pieces or lines.

### IV. CONFIGURING RULES

In systems consistent with the present invention, the end user is permitted to select and configure rules to be used to generate the stocking plan. Rules are generally created, selected and configured according to characteristics of the inventory data identified through the analyze data process of block 24. However, some rules are predefined and apply independently of the characteristics of the inventory data.

For example, in the illustrated embodiment, a predefined rule set used for most types of inventory data includes the following twenty-five rules: validate cost, validate forecast, validate lead time, reset stocking plan, generate forecast accuracy, generate adjusted forecast accuracy, forecast comparison, set new strategy, generate demand statistics, set demand spikes, set critical code, generate economic order quantity, order quantity, calculate turns, set strategy forecast, reset stocking actions, calculate on-hand impact, calculate available quantity impact, calculate stocking strategy impact, remove SKUS with no import data for 6 months, remove demand data greater than 18 months, label SKUs not in the last import, reset order quantity min-max desired, update forecasted lines, and assign forecast method.

One advantage of systems of the present invention, due to the use of a communications network, is that rule sets can be developed by the software vendor using a browser 10 and a server 12 (shown in FIG. 8) located at the vendor's premises, and then transmitted to a server 12 at the end user's premises, via the communications network. The rule set is then incorporated into the end user's system. The end user can test the rule set and provide feedback to the vendor.

Rules can be created and configured based on specific characteristics of the inventory. This can be done “on the fly” through the user interface, or in advance via programming logic. For example, a specific set of rules can be defined for fast moving inventory or inventory with short life cycle products. Each such defined set of rules can be saved for future use. For example, in the illustrated embodiment, an end user selects the particular set of previously created rules that corresponds to the type of inventory the end user is working with. If the end user already knows the characteristics of the inventory, the end user can skip the analyze data process of block 24.

In the illustrated embodiment, rules are organized according to the business environment, inventory, demand, and supply criteria. For example, a rule related to the business environment sets the required overall service level for a particular customer at 98%. An example rule related to inventory sets the required availability at 100% for items that are designated as critical. An example rule related to demand is, “if an item has a demand history, use the demand history to calculate stocking levels.” An example rule related to supply is “item X must be ordered from supplier A.”

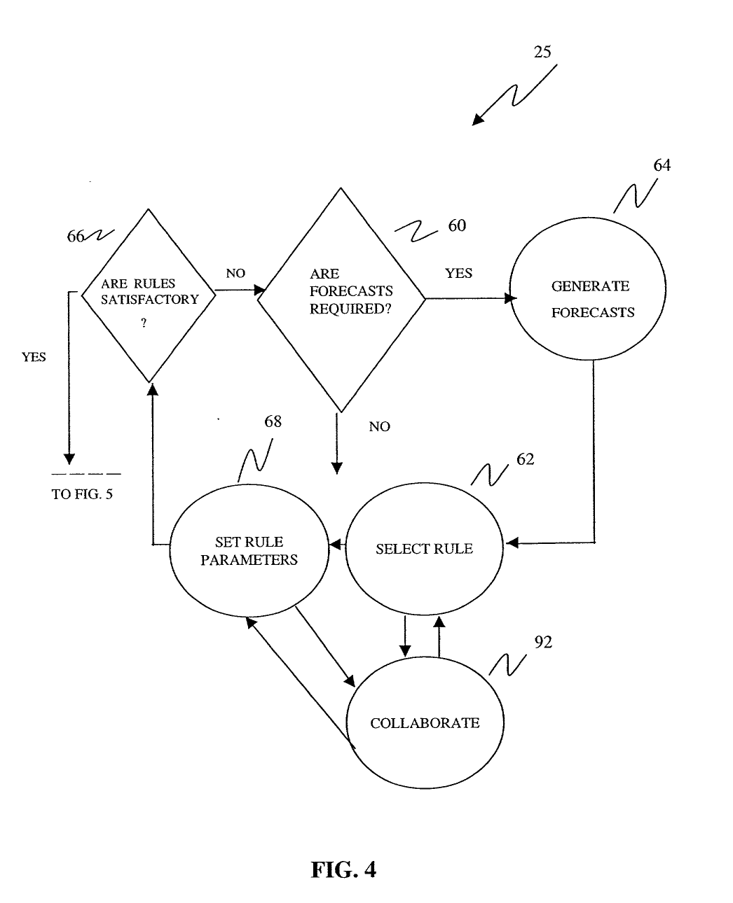

FIG. 4 illustrates the configure rules process of block 25. At block 62, the end user selects rules to be enabled or disabled during the stocking plan generation process of block 26. Alternatively, a user may create a new rule that is customized for its particular inventory data or business objective. Illustratively, the end user uses a user interface (discussed below) such as a computer keyboard, mouse, touch screen, voice recognition device, electronic pen, or the like to create and select the rules to be enabled or disabled. One skilled in the art would readily understand that other input devices may be used to create, select and configure the rules. At block 68, the end user defines the parameters for the selected rules. At block 60, a determination is made as to whether demand forecasts are required for a particular rule. The collaborate process 92 may be run from either the select rule process of block 62 or the set rule parameters process of block 68. At block 66, a decision is made as to whether the current set of rules is sufficient (e.g., complete and/or precise enough) to generate a stocking plan that will satisfy one or more business objectives. The end user determines whether the rule configuration is sufficient by executing the generate stocking plan process of block 26 and reviewing the results. If the results are not satisfactory, the end user repeats the analyze data process of block 24, the select rule process of block 62, or the set rule parameters process of block 68.

If demand forecasts are required, as determined at block 60, the generate forecasts process of block 64 is run as necessary to generate demand forecasts for inventory based on the data that is available in database 14. Generate forecasts process 64 executes forecasting algorithms known in the art, including probability distributions for random variables, and others described in chapter 3 of Probability and Statistics for Engineers, 2nd Ed. (Prentice-Hall, Inc., 1977) hereby incorporated herein by reference. The forecasting algorithms are executed on the inventory data to predict the demand for an inventory item at some time in the future.

In the generate forecasts process of block 64, forecast methods are created and assigned to items in the inventory by item or to a group of items using a filtered rule. A filtered rule is a rule that is only applied to a subset of items described by the filter. Once the forecast methods are assigned, the forecasts are generated. After forecasts are generated, the forecast accuracy is evaluated to look for potential changes that need to be made to the forecast methods. The process of assigning forecast methods and generating forecasts is repeated as needed until the forecast accuracy satisfies the related business objective. Once forecasting methods that satisfy at least one business objective have been identified, the data validation rules are executed against the inventory data, the configure rules process 62 are repeated, or the generate stocking plan process 26 is initiated.

### V. GENERATING A STOCKING PLAN

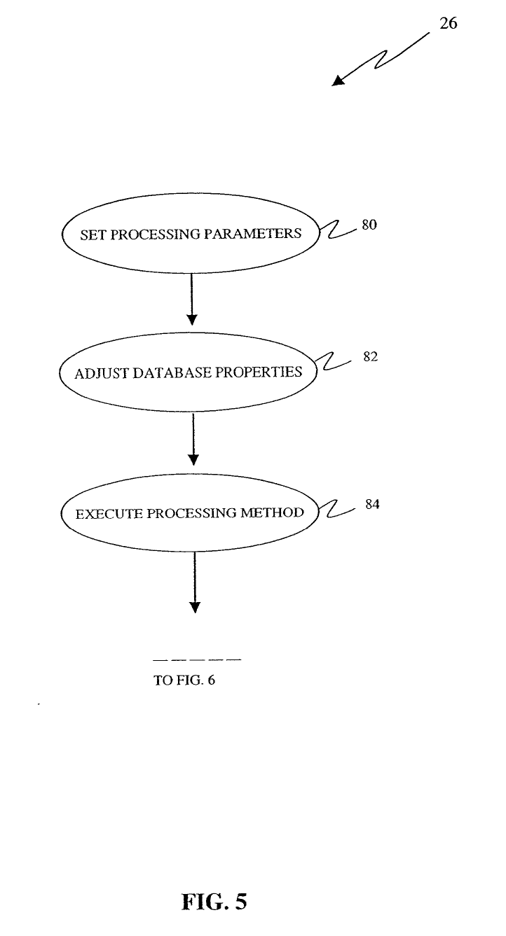

FIG. 5 shows a flow diagram of generate stocking plan process 26. Generate stocking plan process 26 creates a stocking plan that is “optimized” to achieve one or more business objectives. Generate stocking plan process 26 executes inventory optimization algorithms, particularly algorithms that generate a safety stock for the inventory using traditional principles of inventory management under uncertainty known in the inventory management art, in consideration of the selected business objectives. The algorithms used in the illustrated embodiment are implemented in the commercially available LogicStock™ 2.7 software, available from TCLogic, LLC of Indianapolis, Ind. These and other algorithms are described in chapter 4 of Production and Operations Analysis, 3rd Ed. (Irwin, 1997); chapter 13 of Service Parts Handbook, (The Solomon Press, 1997); chapter 12 of Optimization in Operations Research (Prentice-Hall, Inc., 1998); and chapter 9 of Strategic Logistics Management, 2nd Ed. (Irwin, 1987) all of which are hereby incorporated herein by reference.

The result of the generate stocking plan process of block 26 is a stocking plan for an inventory comprised of multiple SKUs, where the stocking plan for the entire inventory meets a selected overall business objective, such as a guaranteed service level for a particular customer. A stocking plan is a function of stocking coverage (which items in an inventory to stock or not stock) and stocking levels (how much of each item to stock). The preferred optimization algorithm used in the generate stocking plan process of block 26 takes as input a “SKU mix,” or grouping of inventory line items, and an objective (such as a service level), generates a cost/availability tradeoff curve and determines the SKU mix required to meet the objective. The output of the optimization algorithms is referred to herein as a stocking plan.

As shown in FIG. 5, the set processing parameters process of block 80 enables the end user to set rule parameters to customize the stocking plan based on characteristics of the inventory data. Customer service level, optimization factoring, package size adjustments, and business days are some of the parameters that can be customized. For example, supplier lead time can be set to be calculated in either calendar days or business days. Different stocking plans can be generated using different sets of rules and rule parameters by activating or deactivating selected rules.

After the set processing parameters process of block 80 is complete, the adjust database properties process of block 82 adjusts the inventory data to be used by the optimization algorithm. For example, if supply lead-time is stored in calendar days, it is converted from calendar days to business days if the parameter was set to use business days at block 80.

After the database properties have been verified, the execute processing method process of block 84 executes the inventory optimization and planning algorithm(s) described above to produce a stocking plan. The results of block 84 are reviewed during the evaluate stocking plan process of block 28.

### VI. EVALUATING A STOCKING PLAN

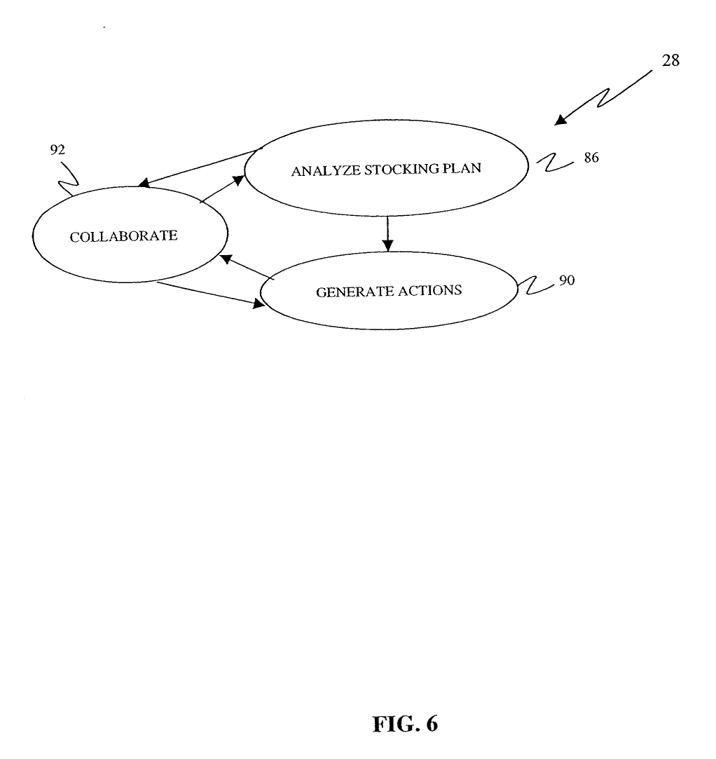

As shown in FIG. 6, the evaluate stocking plan process of block 28 includes the analyze stocking plan process of block 86, the generate actions process of block 90 and the collaborate process of block 92. During the analyze stocking plan process of block 86, the stocking plan is analyzed. In the illustrated embodiment, ABC analysis, which is an analytical technique well known in the inventory management art, is used to identify those SKUs that have the most significant impact on the stocking plan. This and other rules for evaluating the stocking plan are selectively enabled and disabled, and configured, by the end user, similar to the rules for analyzing the inventory data and generating the stocking plan.

The generate actions process of block 90 enables end users to study and identify recommended actions for implementing the new stocking plan. Views of the data are generated that give summary and detail item information, show the differences between the current position and the new stocking plan, and describe the actions required to achieve the new plan. Alternatively, one stocking plan may be analyzed in view of one or more other stocking plans that have been generated using different inventory data or rules to determine which of the stocking plans is most feasible to implement.

The generate actions process of block 90 identifies new items that need to be added to the inventory and existing items that need to be deleted from the inventory in order to achieve the new stocking plan. End users evaluate this information and decide whether to take one of several possible actions, including but not limited to changing rules or parameters and generating a new stocking plan, overriding specific stocking recommendations, performing additional analyses to investigate the cost of stocking or not stocking specific items, importing more or different inventory data and generating a new stocking plan, and updating the database 14 to reallocate items to another location in the supply chain. An end user may execute the collaborate process of block 92 from either block 86 or block 90.

### VII. EXAMPLE

An example of the interplay between the processes of blocks 24, 25, 26 and 28, consistent with the illustrated embodiments of the present invention, follows. A set of inventory data includes inventory of an industrial distributor with a wide variety of SKUs in the inventory. The distributor has a business objective of providing a guaranteed service level of 95% at its Atlanta location while minimizing inventory costs.

The inventory data, including current demand forecasts, for the Atlanta location is imported into the database 14 for each of 12 months. The end user selects a view of the inventory data that displays the number of SKUs sold in each of the 12 months, the forecasted demand, and the actual on-hand inventory for each of the 12 months. The on-hand inventory for the first month is $151,874 and the current inventory turns is 0. The user notices from the view that the current forecasted demand is much less than the current on-hand inventory, i.e., on-hand inventory is probably too high.

Based on the characteristics of the inventory data, the user selects the following rules to be enabled when the stocking plan is generated: calculate safety stock and calculate cycle stock, using a user interface as discussed above. The user configures both of these rules to use the same forecast method. The user sets the forecast method to be used to take the average demand for items including only those periods in which items were sold (ignoring months in which no items were sold). The user runs the generate stocking plan process of block 26.

The results, which include a recommendation as to items that should be stocked and not stocked, and the stocking levels for the items to be stocked, show the projected on-hand inventory for the first month at $89,919 and the new inventory turns at 3.8.

From analyzing the view of the inventory data, the user determines that certain items sell more slowly than others in the inventory. The user changes the calculate cycle stock rule for the slow moving items, using the user interface, so that the rule uses a different forecast method than the calculate safety stock rule. The user sets the forecast method for the new calculate cycle stock rule so that it includes periods in which no sales were made. The user runs the generate stocking plan process of block 26 again. The results show a projected on-hand inventory of $47,884 and new inventory turns at 6.6.

### VIII. COLLABORATION

Shown in FIG. 6, the collaborate process of block 92 is run to enable end users of the system of the illustrated embodiments to collaborate, or provide input to one another, while analyzing the inventory data, rules, or stocking plan. For example, the collaborate process of block 92 can be used to obtain information or feedback on a stocking plan from suppliers of inventory items in a supply chain.

The following is an example of how collaboration is used. If a company's business objectives require a 98% service level at a specified lowest cost, but the cost to provide that service level is greater than the company can afford, an inventory planner may solicit electronic comments from other system users on how best to meet the service level. A comment from a user suggests that some items be obtained through a special purchase. This information is communicated to the planner electronically through use of the collaboration process of block 92.

The collaboration process of block 92 is implemented over a communications network, such as the Internet. The collaboration process of block 92 allows different end users to provide input electronically to one another or directly into the database 14. In the illustrated embodiment, each comment or input is linked to a particular end user and a particular SKU, rule or stocking plan. Collaboration data sets define the data, rules or plans about which each end user is permitted to submit comments. Comment categories are used to electronically aggregate problem issues according to a preselected criteria, such as a type of comment (e.g., “Explanation of slow moving items”).

An end user is notified that he or she must comment on a particular SKU, and the type of comment required (e.g., the comment category), through the user interface. For example, when a user generates a view of the inventory data during the analyze data process of block 24, a graphic is displayed next to a SKU item on the display screen to notify the user to comment on that SKU. The notification instructs the user of the type of comment that is required. For examples, a rule might require users to issue a comment to explain why inventory turns for a particular item are less than 2.

### IX. EXPORTING STOCKING PLANS

The results of the processes of blocks 24, 26, and 28 are made available to computer systems, software applications, or devices that directly manage the inventory ordering process. In the illustrated embodiment, the results are exported from the system of the present invention and uploaded directly into an external system.

FIG. 7 shows a flow diagram of the export process of block 99. The create export plan process of block 100 creates a file name for the destination file to which data is to be exported, determines the destination file type, and the location of the destination file. The create export map process of block 102 maps data in the destination file to the resident location in the database 14. Multiple export maps may be created to enable data to be exported to various systems. The export map is determined by the system to which data is being exported. At decision block 104, the system of the illustrated embodiment determines whether any export rules need to be set. If any rules need to be set, export rules such as filters and data transformation rules, e.g., rules for formatting business days, are set by the set rules process of block 106. For example, another system may only be updated if the new stocking plan is at least 5% higher or lower than the current plan. Export filters enable specific data elements to be filtered during the export file creation process by allowing the user to define data fields to be excluded and to drill down on each filter to see what data elements are excluded. The execute export process of block 108 exports the data to a destination file or database or directly into another system, such as an ERP system.

### X. USER INTERFACE

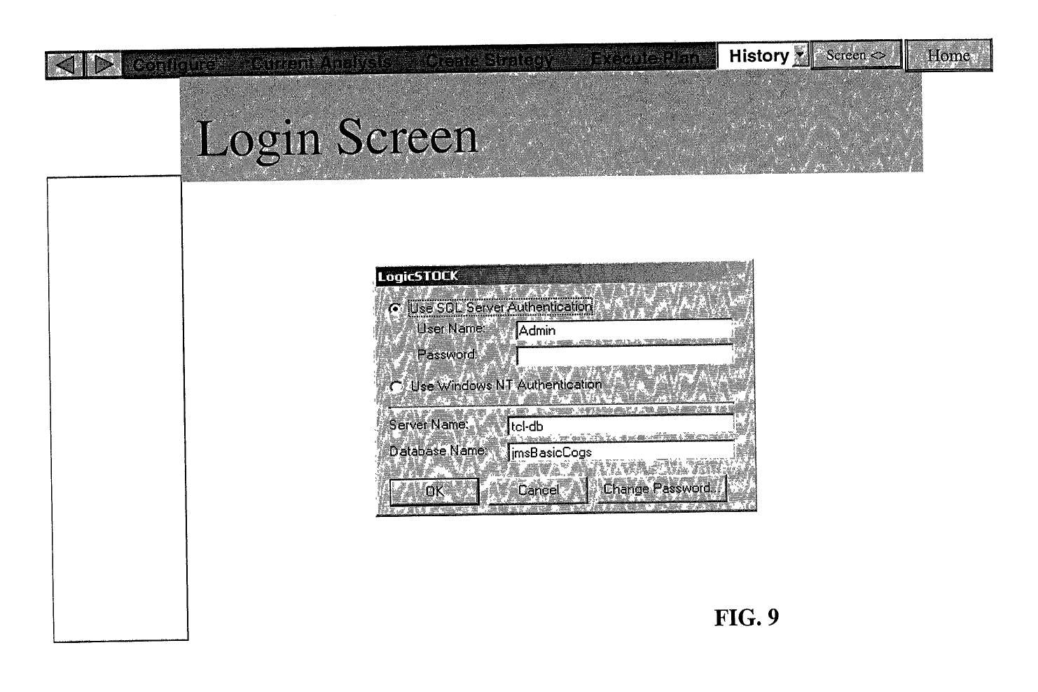

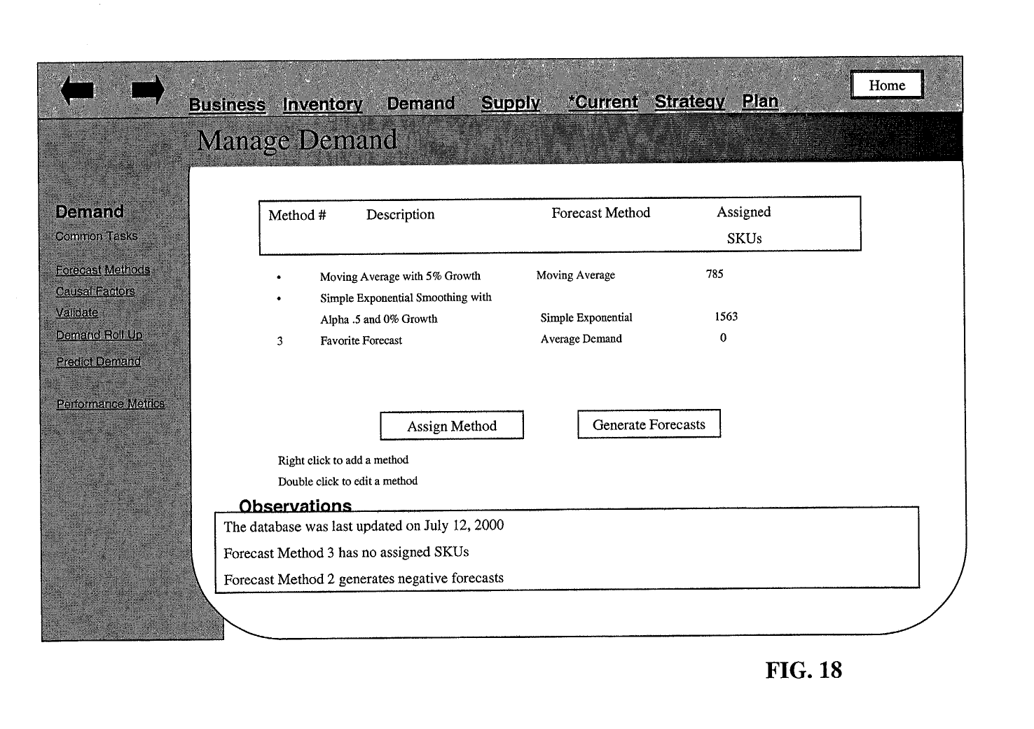

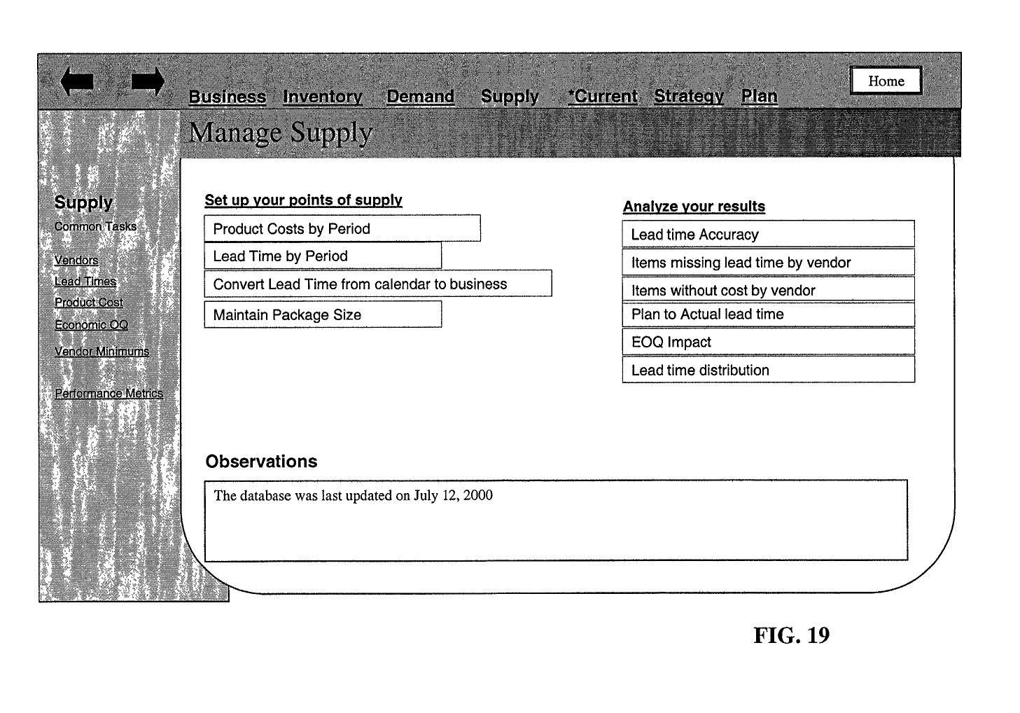

There are many ways to design and configure user interfaces for operating the features of the present invention. FIGS. 9-27 are example user interfaces consistent with the present invention, but should not be construed as limiting the present invention to the specific designs of the user interfaces shown.

FIG. 9 shows an example login screen of a user interface of a system of the present invention. Each end user enters a user name and password that has been authorized by the system administrator. Each end user's access may be restricted to particular servers, databases, inventory data, features and processes.

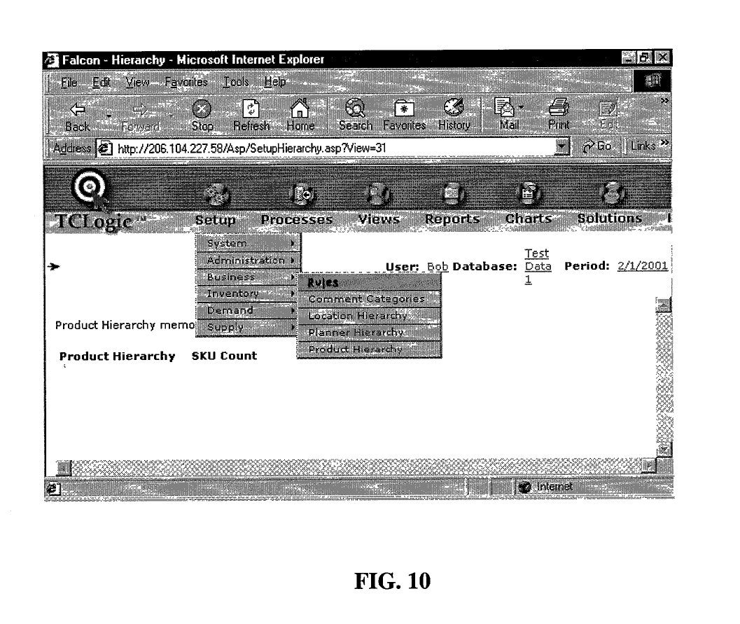

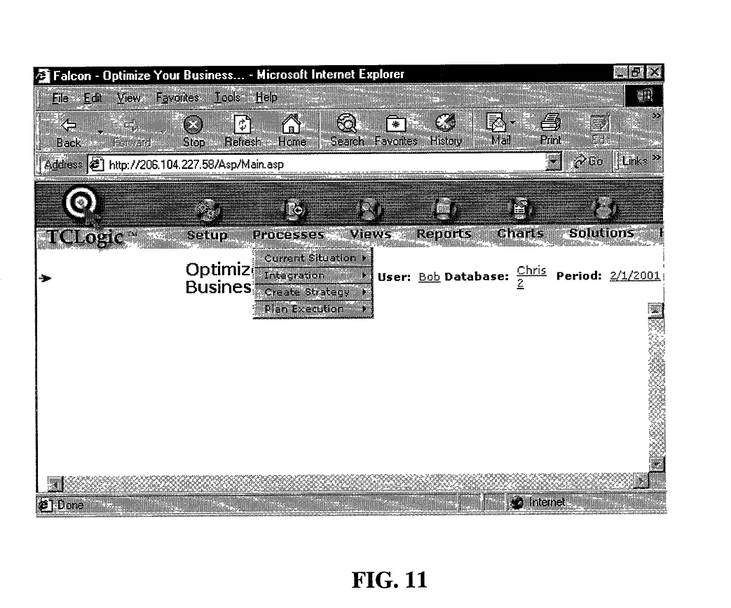

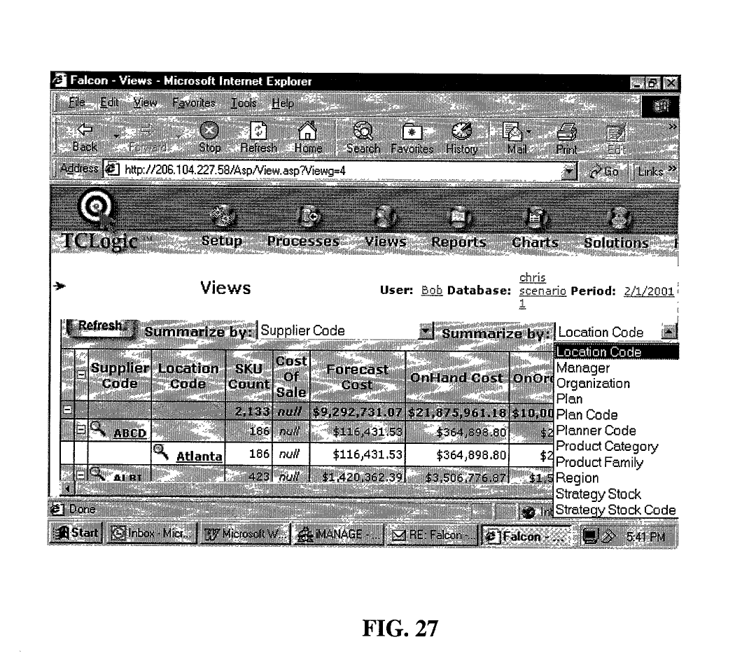

After being approved to access the system, a main screen such as shown in FIG. 10 is presented to the user, illustratively via a Web browser. FIG. 10 displays the activities that may be performed by the user. Under the “setup” pull down menu, the end user is presented options for importing and exporting inventory data, defining the set of rules to use to analyze the inventory data and generate a stocking plan, and configuring rules related to business, inventory, demand, and supply. Under the “processes” menu, the end user selects a process to be run from the processes of blocks 22-29 of FIG. 1, as shown in FIG. 11. The “views” menu permits the end user to display a view created by the analyze data process of block 24. FIG. 27 shows an example view where the inventory data is grouped by supplier code and location. The “reports” and “charts” menus provide reports and charts showing the results of analyze data process 24, generate stocking plan 26 or evaluate stocking plan 28. The “solutions” menu permits the user to save as a preset “solution”, which is a particular combination of rules to be used to generate a stocking plan or analyze the data. For example, a particular group of rules configured in a certain way yields the best stocking plan for slow moving inventory. The user can create a “solution” specifically for slow moving inventory or other types of inventory.

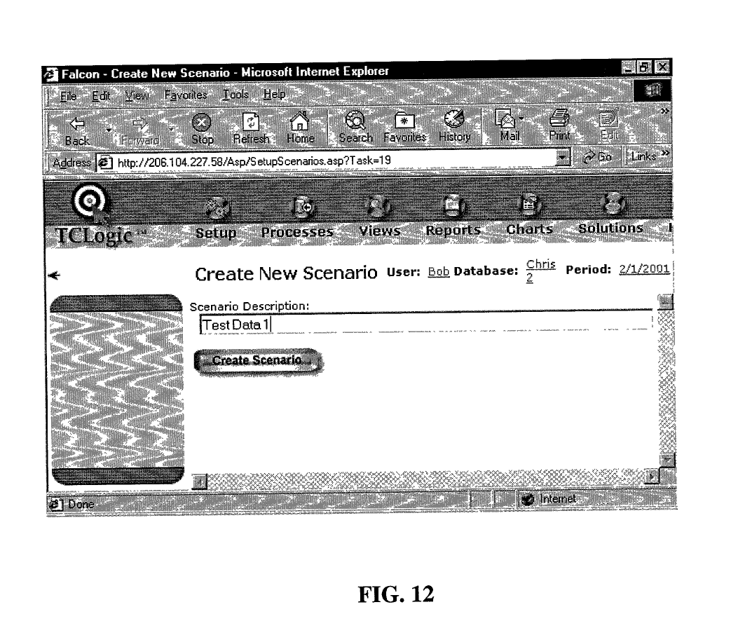

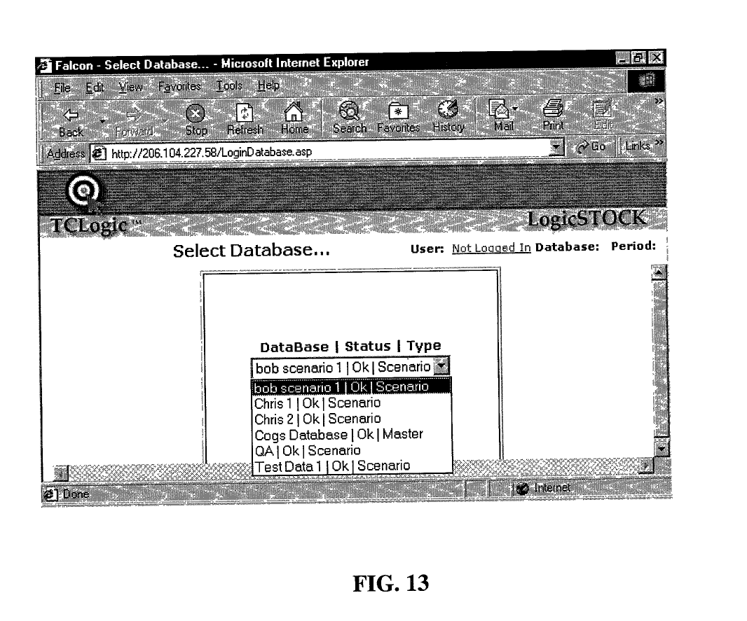

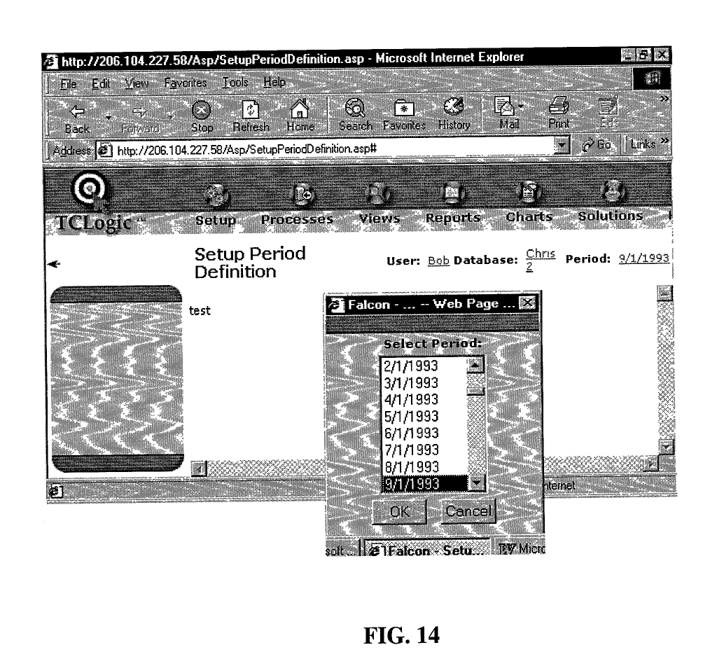

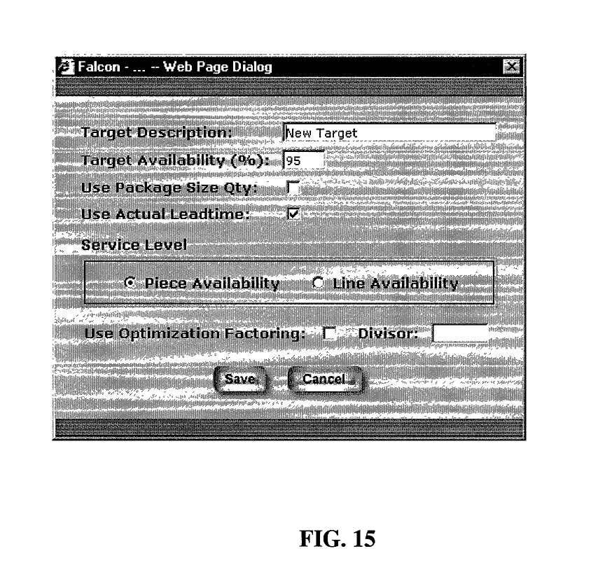

To begin working in the system, the user makes a copy of the structure of database 14 by creating a scenario, as shown in FIG. 12. As discussed above, a scenario is a combination of data, rules, views, and stocking plans associated with a particular user. Each user can be associated with multiple scenarios. As shown in FIG. 13, the user selects the particular scenario that will be used during the current work session. As shown in FIG. 14, the user selects a particular period of data in the scenario to work with in the current session. While FIG. 14 illustrates the period as a time period, the period can be defined any way the end user wants. For example, the first period includes data for the last three months of last year for the Atlanta location, while the second period includes data for the Miami location for all of last year for only large widgets. As shown in FIG. 15, the user enters the business objective information via the user interface.

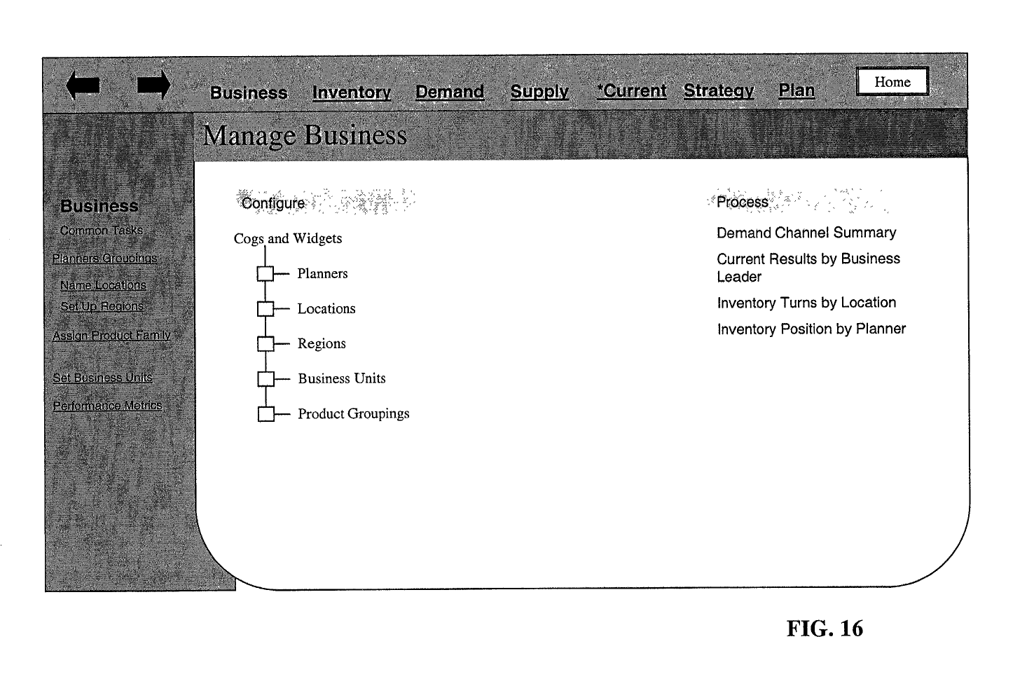

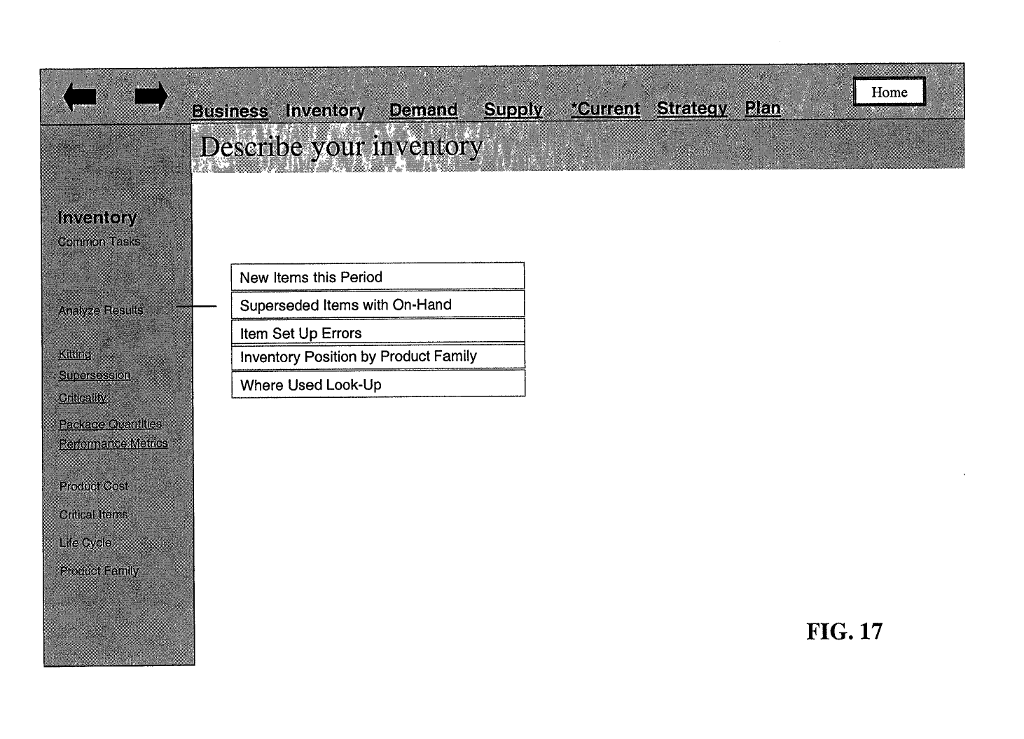

Once inventory data has been received into the system, the end user sets up rules to be used to analyze inventory data and generate a stocking plan. FIGS. 16-19 show example user interfaces for configuring and processing business, inventory, demand and supply rules. FIG. 16 shows examples of the types of business data and related rules that are analyzed and configured, including: inventory planner information (e.g., name, description, and planner level); location information (e.g., location code, name and description); region information (e.g., region name, description, and associated location codes); business units (e.g., business unit name, such as “Consumer Products”, description, and products associated with the business unit); and product groupings (e.g., product or brand information and the groupings to which each belongs). In addition, FIG. 16 lists example analysis methods that are included in illustrated embodiments of the present invention. For example, calculating the number of inventory turns by location may identify locations with low inventory turns. Accordingly, the stocking strategy may be adjusted to require fewer items to be stocked at those locations. Similarly, rules related to inventory (e.g., kitting, superseding items, criticality, package quantity), demand (e.g., forecast methods, demand spikes, strategy and line item forecasts), and supply (e.g., vendors, lead time, product cost, economic order quantity and vendor minimums) is created, analyzed, and modified through user interfaces such as those depicted in FIGS. 17-19.

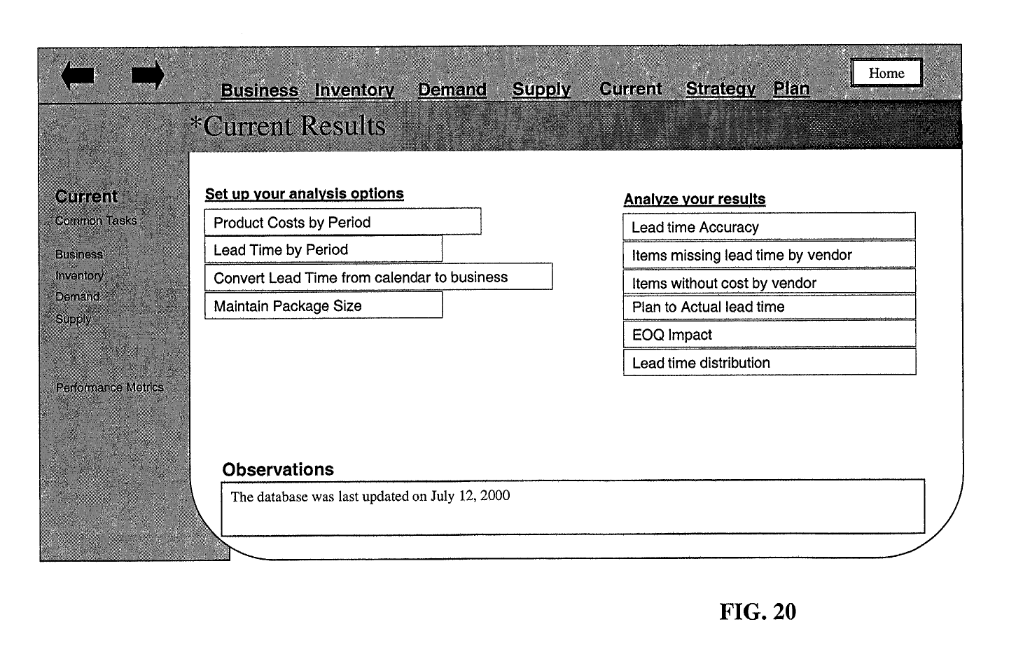

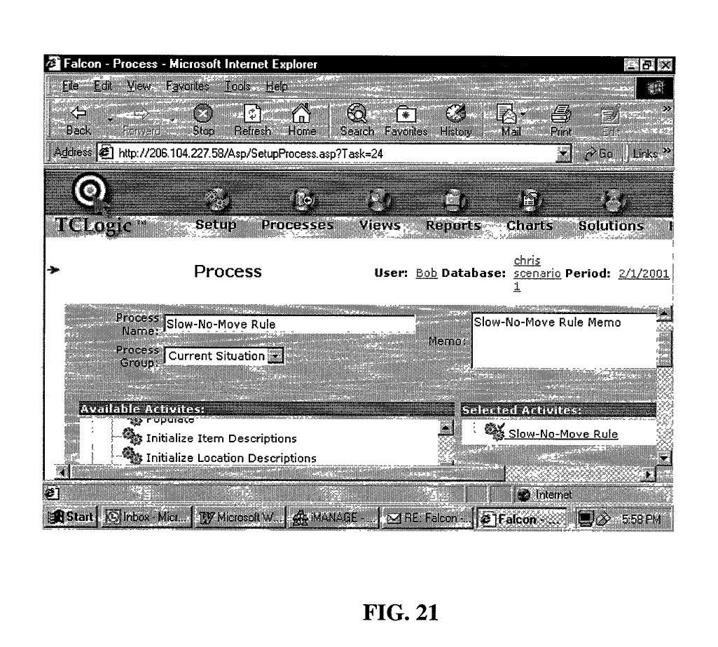

As shown in FIG. 20, examples of algorithms for analyzing the inventory data at block 24 include lead time accuracy, planned to actual lead time, economic order quantity impact, and lead time distribution. As shown in FIG. 21, a user can set up a particular analysis process, e.g., for analyzing slow/no move inventory, by selecting from a listing of available activities to include in the process.

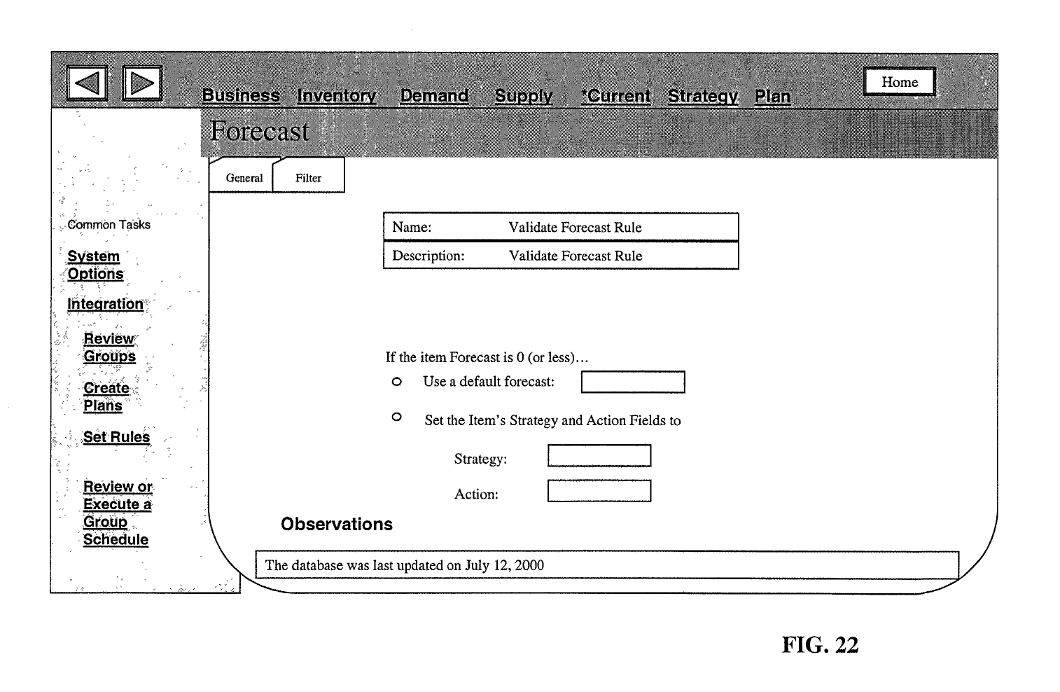

FIG. 22 shows an example user interface for the configuring rules process of block 25. FIG. 22 shows the type of information required to create a “validate forecast” rule. Other rules used by the processes of blocks 22-28 are configured in a similar manner.

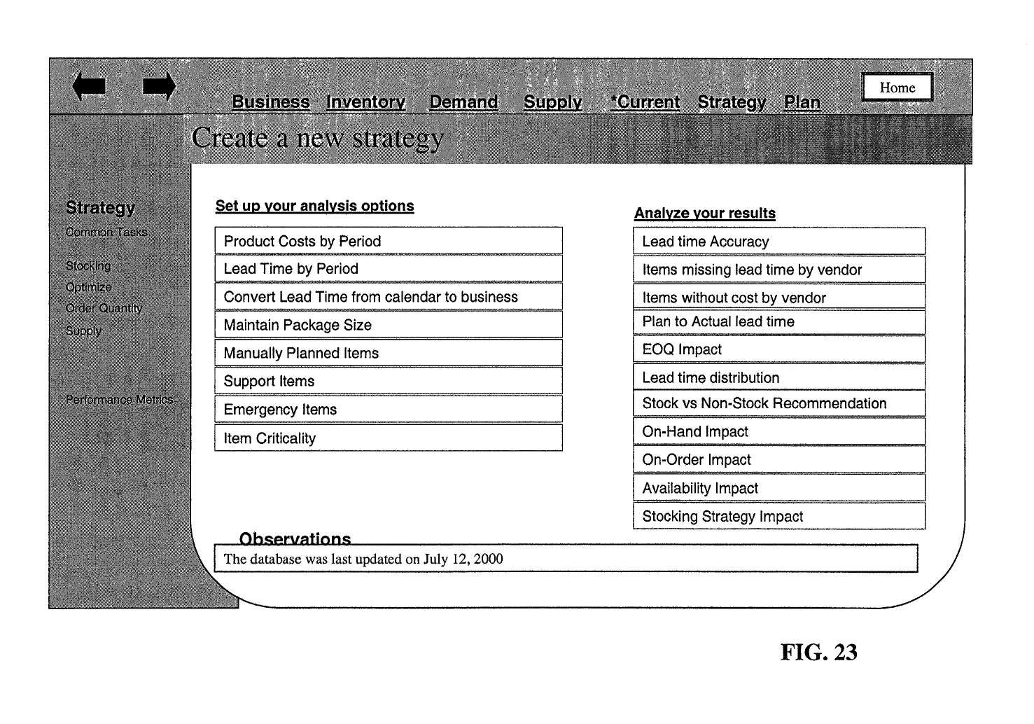

FIG. 23 shows an example user interface for the generate stocking plan process of block 26. Users configure options for analyzing the stocking plan, such as product costs by period, lead time by period, convert lead time from calendar to business, maintain package size, manually planned items, support items, emergency items, or item criticality. Then, users generate the stocking plan and analyze the results.

The available analyses include lead time accuracy, items missing, lead time by vendor, items without cost by vendor, plan to actual lead time, economic order quantity impact, lead time distribution, stock versus non-stock, recommendation, on-hand impact, on-order impact, availability impact and stocking strategy impact. For example, a user can identify an item in an inventory as an emergency item, and then quickly review the impact of this decision on availability, lead-time, or other factors by running the appropriate algorithms.

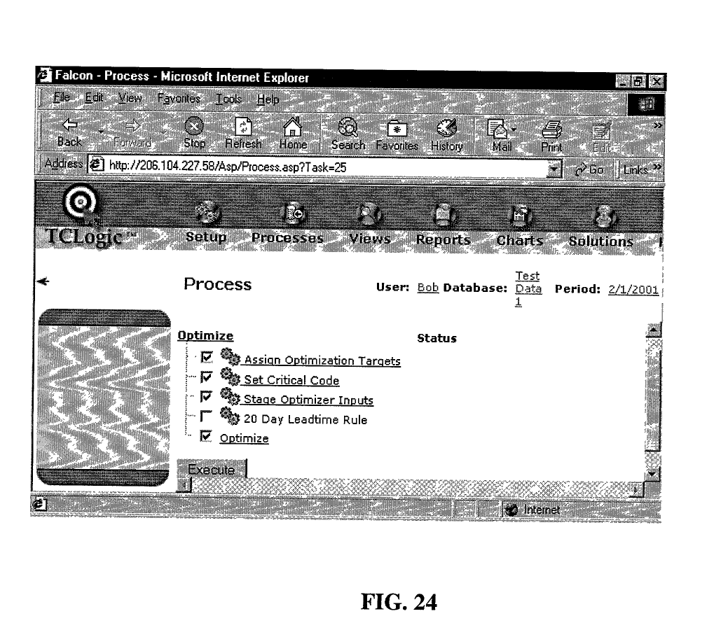

FIG. 24 shows how rules can be selectively enabled or disabled to test the impact of the rule on the stocking plan. In the illustrated embodiment, the end user uses a mouse to click the boxes below the “optimize” heading to enable the rules (as indicated by a check symbol (“√”) in the box shown next to the rule). To disable a rule, the end user clicks the box again, and the check symbol is removed. One skilled in the art of user interface development would readily understand that other methods for selectively enabling and disabling rules may be used, such as a radio button or push button. Similar user interfaces are used for the processes of blocks 24, 25 and 28.

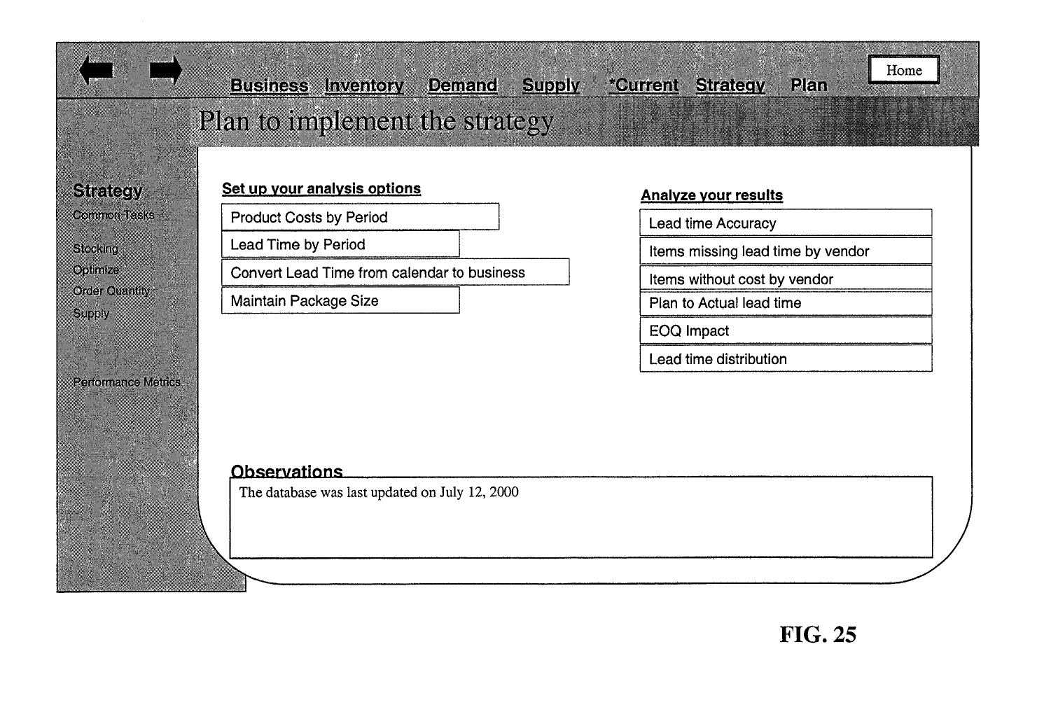

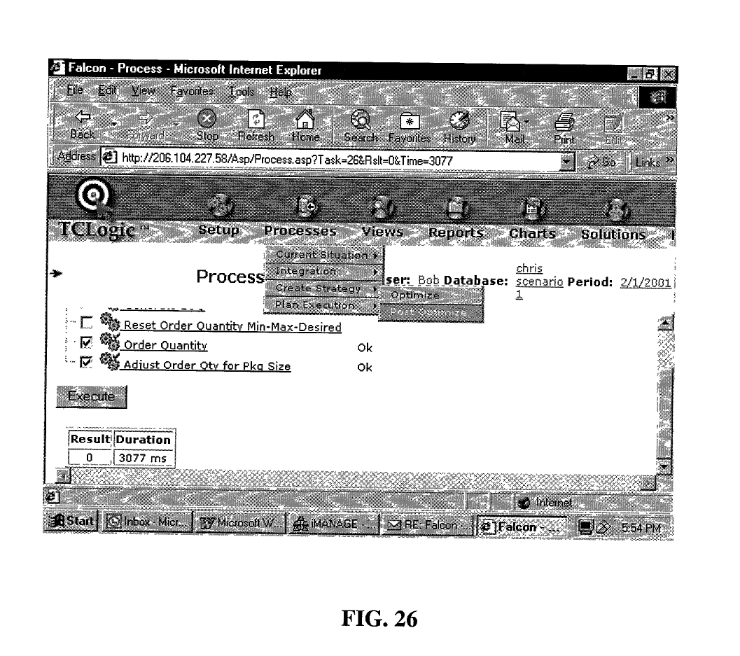

FIG. 25 shows an exemplary user interface for the evaluate stocking plan process of block 28. As FIG. 25 illustrates, users can create a plan for implementing a stocking strategy by iteratively modifying or adding rules and characteristics using the user interface and executing algorithms to determine the impact of those changes or additions on the stocking plan. For example, users can configure selected analyses by product cost, lead time, or package size and then review the results of the selected analysis (i.e., lead time accuracy, etc.). FIG. 26 shows how a user can selectively enable or disable rules for the post-stocking plan analyses by clicking the appropriate check box to enable or disable each rule. As mentioned above, push buttons, radio buttons, or other user interface tools may be used in place of the check box.

Systems of the prior art generally require methods of computing a stocking plan to be selected and configured through programming logic. The ability to selectively enable and disable rules via the user interface is a powerful aspect of the present invention because it enables users to configure and compare multiple customized stocking plans in real time, resulting in a more refined stocking plan that is more finely tuned to the business objectives. Because rules can be configured in real time, the systems of the present invention are capable of accommodating the dynamic nature of inventory.

### XI. SYSTEM BLOCK DIAGRAM

FIG. 8 shows a block diagram of the illustrated embodiment of the present invention, comprising browser 10, server 12, database 14, scheduler engine software 16, activity dispatcher software 18, and a plurality of activity engine software programs 20 that operate on the inventory data and execute inventory analysis and planning activities.

Browser 10 is illustratively implemented using commercially available Internet browser software on a user interface such as a personal computer, workstation or other device or utility for accessing computer networks such as a handheld digital assistant. Browser 10 is in two-way communication with server 12, illustratively using client side java script, a non-proprietary scripting language currently well known in the art. Browser 10 may reside at any location that has access to a communications network to which Server 12 also has access, including the end customer or the vendor of the software or services relating to the software.

Server 12 is in two-way communication with database 14, illustratively using server side VBscript and C++ COM modules. Database 14 is in two-way communication with activity dispatcher 18, using a first queue to communicate information to database 14 and a second queue to receive information from database 14. Database 14 is comprised of a plurality of logical databases, as shown in FIGS. 28-32. Scheduler engine 16 interacts with database 14 periodically to poll database 14 for tasks and populate the second queue. Server 12 may reside at any location that has access to which browsers 10 also have access, including the end customer or the vendor of the software or software-related services.

The illustrated embodiment of the present invention has a private Web address on a global communications network. Other security measures, such as secure logins, passwords, and database access restrictions are also available in illustrative embodiments.

As shown in FIG. 8, activity dispatcher 18 communicates with a plurality of activity engines 20 through TCP/IP sockets, wherein each socket input to an activity engine is a carriage return-delimited string. One skilled in the art of network programming would understand that a socket is a software abstraction used to interconnect software applications via a networking protocol. The activity dispatcher 18 is a dialog-based software application that is responsible for (i) retrieving and executing the inventory analysis and planning-related activities 202-220 associated with a request submitted by an end-user; (ii) dispatching the activities 202-220 to the relevant activity engine; (iii) enforcing the dependency relationships between activities 202-220; and (iv) load balancing across multiple instances of the same activity engine 202-220 when multiple users are executing the same activity 202-220 at the same time. The activity dispatcher 18 manages the sequence of activities 202-220 to be performed and keeps track of the activities, which may be executed on different machines connected via a global communications network. Thus, the activity dispatcher 18 enables the processing required by embodiments of the present invention to be distributed among multiple servers in multiple locations across the network.

Each activity engine 202-220 is a multi-threaded standalone executable program file that may be located on a remote computer or similar device (such as a handheld, wireless computing device). As shown in FIG. 22, an activity is a data object that represents a unit of useful work. Activities can be dependent upon other activities. An ordered sequence of activities is a task. An ordered sequence of tasks is a scenario, and a run is a scenario that is scheduled for execution at some point in time. This logical organization enables users of systems consistent with the present invention to set up multiple runs including different combinations of activities. Activities associated with each activity engine 202-220 are discussed above. The activity dispatcher 18 retrieves the activities associated with a request submitted by an end user. The activity dispatcher 18 opens a socket to the activity engine 202-220 and sends a carriage return delimited string to the activity engine. The activity engine 202-220 then executes the programming logic to achieve functionality embodied in the request. For example, the rule execution activity engine 206 might be told to execute Rule 15. Rule 15 might be the rule that generates the “slow-no move” classification of the inventory. If this rule is implemented as a SQL statement, the SQL statement is run against database 14. After the SQL statement is executed, the error status is returned to the activity engine 206, which in turn returns the status to the activity dispatcher 18.

Systems consistent with the present invention are implemented using the technological environment of the World Wide Web or equivalent global communications network, Web page development tools such as ASP and HTML, and computer software development tools such as the SQL, Visual Basic and C++ programming languages. Persons skilled in the computer programming art would readily understand that other programming languages may be used. In addition, those skilled in the art would understand that the present invention may be implemented over a local area network, intranet, dial-up system or other networked system.

Server 12 is illustratively implemented using Microsoft Windows 2000 Server operating system, SQL7 Standard Edition with SP2, Microsoft Internet Information Server 5.0 and ASP 3.0, and Microsoft Transaction Server 2.0. The computer hardware used as the server computer in the illustrated embodiment of the present invention is a Dell 4400 model having dual CPU 733 Mhz Xeon processors00 with 256 k cache, 512 Mb RAM memory, 4-18 GB 10 k RPM Ultra 3 SCSI drives, 100 Mbit onboard network interface card and Perc 3/Di dual channel embedded RAID controller, or equivalent class of hardware. Those skilled in the computer science art would readily understand that other brands and classes of hardware, software, equipment, and operating systems can be utilized with equal effectiveness.

Although specific illustrated embodiments of the invention have been disclosed, it is understood by those of skill in the art that changes in form and details may be made without departing from the spirit and scope of the invention. The present invention is in no way limited to the details disclosed herein. Accordingly, the present invention is to be defined and limited solely by the scope of the claims.

1. A method for creating an optimal inventory, the method comprising the steps of:
analyzing item data;
identifying one or more dynamic characteristics of the data that significantly affect the one or more business objectives;
dynamically configuring via a user interface a plurality of rules based on one or more dynamic business objectives and the characteristics of the item data that significantly affect the one or more business objectives;
executing the plurality of rules;
selecting at least one item to be included in the inventory;
determining, for each of the selected items, a quantity to be stocked;
evaluating the inventory in relation to the one or more business objectives prior to implementing the inventory; and
repeating the above steps to optimize the inventory as the characteristics and business objectives change.

2. The method of claim 1, wherein each of the plurality of rules is selectively enabled and disabled via the user interface.

3. The method of claim 2, wherein a pointing device is used to selectively enable and disable the plurality of rules.

4. The method of claim 3, wherein the pointing device is one of a computer mouse, a track ball, a touchpad, a pointing stick, and an electronic pen.

5. The method of claim 1, wherein the user interface is a graphical user interface.

6. The method of claim 1, wherein the user interface is displayed via a web browser.

7. The method of claim 2, wherein the user interface includes selection areas for selectively enabling and disabling the plurality of rules.

8. The method of claim 7, wherein the selection areas are defined by a user interface control.

9. The method of claim 8, wherein the user interface control is one of a check box, a radio button, and a push button.

10. The method of claim 1, wherein parameters for each of the plurality of rules are defined via the user interface.

11. The method of claim 1, further comprising the steps of:
selectively adjusting via a user interface the plurality of rules in accordance with the business objective; and
repeating the generating step and the evaluating step.

12. The method of claim 1, further comprising the step of:
repeating the analyzing, configuring, generating, and evaluating steps as necessary to update the stocking plan.

13. The method of claim 1, wherein the stocking plan identifies at least one inventory item to be stocked and a quantity to be stocked for each inventory item.

14. The method of claim 1, wherein the stocking plan identifies at least one inventory item not to be stocked.

15. The method of claim 1, further comprising the steps of:
reviewing the stocking plan via a web browser on a remote computer; and
providing input related to the stocking plan via the web browser.

16. The method of claim 1, wherein the plurality of rules includes at least one rule relating to each of a business environment of the inventory, a supplier of the inventory, a demand for an item in the inventory, and an item in the inventory.

17. The method of claim 1, wherein the user interface is accessed via a global communications network.

18. The method of claim 1, wherein the stocking plan includes a pictorial representation of the stocking plan.

19. The method of claim 1, further comprising the steps of:
selecting via the user interface a first group of the inventory data according to a first criterion;
generating a first stocking plan using the first group of the inventory data;
selecting via the user interface a second group of the inventory data according to a second criterion;
generating a second stocking plain using the second group of the inventory data; and
selecting one of the first stocking plan and the second stocking plan in accordance with the business objective.

20. The method of claim 19, wherein the first criterion is a first time period and the second criterion is a second time period.

21. The method of claim 20, wherein the first time period is a first month and the second time period is a second month.

22. The method of claim 20, wherein the first time period and the second time period each comprise a plurality of days.

23. The method of claim 19, wherein the first criterion and the second criterion are related to the inventory.

24. The method of claim 19, wherein the first criterion and the second criterion are related to a business unit of the inventory.

25. The method of claim 19, wherein the first criterion and the second criterion are related to a location of the inventory.

26. The method of claim 19, further comprising the step of displaying the first stocking plan and the second stocking plan on the user interface.

27. The method of claim 26, wherein the first and second stocking plans are displayed side by side on the user interface.

28. The method of claim 1, wherein the generating step includes the steps of:
generating a plurality of stocking plans based on the inventory data and the plurality of rules; and
selecting an optimum stocking plan from the plurality of stocking plans based on the at least one business objective.

29. The method of claim 28, wherein at least one of the rules is different for each of the stocking plans.

30. The method of claim 28, wherein the inventory data is different for each of the stocking plans.

31. The method of claim 28, wherein the plurality of stocking plans is displayed via a user interface.

32. The method of claim 31, wherein the plurality of stocking plans are displayed side by side on the user interface.

33. The method of claim 1, further comprising the steps of:
performing via a user interface a plurality of steps, the plurality of steps including selecting a business objective, selecting a group of the inventory data based on a predetermined criterion, selecting a method of generating the stocking plan, selecting at least one rule for generating the stocking plan, and configuring the at least one rule for generating the stocking plan;
executing the selected method using the selected business objective, the selected group of data and the selected rules to generate a first stocking plan;
changing via the user interface one of the selected method, business objective, group of data, and rules;
generating a second stocking plan; and
selecting one of the first stocking plan and the second stocking plan in accordance with the business objective.

34. The method of claim 33, wherein the user interface is a graphical user interface.

35. The method of claim 33, wherein the user interface is accessed via a global communications network.

36. The method of claim 33, further comprising the step of displaying the first stocking plan and the second stocking plan on the user interface.

37. The method of claim 36, wherein the first stocking plan and the second stocking plan are displayed side by side on the user interface.

38. The method of claim 1, further comprising the steps of:
receiving the inventory data from at least one remote data source;
storing the inventory data in a computer memory;
defining the plurality of rules based on the inventory data and the at least one business objective, the plurality of rules comprising:
at least one rule related to a business environment of the inventory;
at least one rule related to the inventory;
at least one rule related to a demand for the inventory;
at least one rule related to a supplier of the inventory; and
generating the stocking plan in accordance with the plurality of rules.

39. The method of claim 38, wherein the at least one rule related to a business environment includes a rule related to a financial objective.

40. The method of claim 38, wherein the at least one rule related to a business environment includes a rule related to a company mission.

41. The method of claim 38, wherein the at least one rule related to a business environment includes a rule related to a service level.

42. The method of claim 38, wherein the at least one rule related to a business environment includes a rule related to inventory turns.

43. The method of claim 38, wherein the at least one rule related to the inventory includes a rule related to an availability of an item in the inventory.

44. The method of claim 38, wherein the at least one rule related to the inventory includes a rule related to a quantity of an item in the inventory.

45. The method of claim 38, wherein the at least one rule related to the inventory includes a rule related to a location of an item in the inventory.

46. The method of claim 38, wherein the at least one rule related to a demand for the inventory includes at least one rule related to the demand history of an item in the inventory.

47. The method of claim 38, wherein the at least one rule related to a demand for the inventory includes at least one rule related to a demand forecast.

48. The method of claim 38, wherein the at least one rule related to a demand for the inventory includes at least one rule related to a package quantity for an item in the inventory.

49. The method of claim 38, wherein the at least one rule related to a supplier of the inventory includes at least one rule related to the supplier's lead time.

50. The method of claim 38, wherein the at least one rule related to a supplier of the inventory includes at least one rule related to the supplier's order policies.

51. The method of claim 38, wherein the at least one rule related to a supplier of the inventory includes at least one rule related to the supplier's package quantities.

52. The method of claim 38, wherein the at least one rule related to a supplier of the inventory includes at least one rule related to the supplier's cost.

53. The method of claim 1, further comprising the steps of:
accessing one of the inventory data, the plurality of rules and the stocking plan on the main computer from a remote computer;
reviewing via a web browser on the remote computer the one of the inventory data, the plurality of rules, and the stocking plan;
creating via the web browser a message relating to the one of the inventory data, the plurality of rules, and the stocking plan; and
transmitting the message from the remote computer to the main computer.

54. The method of claim 53, further comprising the step of transmitting the message to a second remote computer.

55. The method of claim 54, further comprising the step of determining whether to display the message to a user of the second remote computer.

56. (Cancelled).

57. The method of claim 1, further comprising the steps of:
receiving the inventory data from a remote data source;
grouping the inventory data according to business, inventory, demand and supply criteria; and
storing the grouped data in the computer memory.

58. The method of claim 57, further comprising the step of:
indexing the inventory data according to one of an item identifier, a time period, and a user identifier.

59. The method of claim 57, further comprising the step of indexing the inventory data according to an item identifier, a time period, and a user identifier.

60. The method of claim 57, wherein the computer memory includes a database.

61. The method of claim 58, wherein the database includes one of a multidimensional database, a data malt, and a data warehouse.

62-64. (Cancelled).

65. The method of claim 1, further comprising the steps of:
creating a plurality of solution paths, wherein each solution path comprises a subset of the inventory data, a first plurality of rules for analyzing the subset of the inventory data, and a second plurality of rules for generating the stocking plan;
testing the plurality of solution paths on the subset of the inventory data by generating a plurality of stocking plans;
comparing the plurality of stocking plans to the preselected objective; and
storing a solution path that generated an optimum stocking plan relative to the preselected objective.

66. The method of claim 65, further comprising the step of:
associating a solution path with an end user.

67. The method of claim 1, comprising the steps of:
selecting via the user interface a group of inventory data from the inventory data stored in the computer memory;
storing the group of inventory data in a database;
selectively enabling via the user interface a plurality of rules for analyzing the group of inventory data;
executing the plurality of selectively enabled rules for analyzing the group of inventory data to generate a display of the group of inventory data;
analyzing the display of the group of the inventory data via the user interface to identify a characteristic of the group of the inventory data;
selectively enabling via the user interface a plurality of rules for generating a stocking plan in accordance with the business objective and the characteristic;
executing the plurality of selectively enabled rules for generating a stocking plan to generate the stocking plan;
selectively enabling via the user interface a plurality of rules for evaluating the stocking plan;
executing the plurality of rules for evaluating the stocking plan to generate a display of the stocking plan; and
analyzing the display of the stocking plan to determine whether the stocking plan satisfies the business objective.

68. The method of claim 66, wherein the stocking plan includes a plurality of stocking plans and further comprising the step of:
selecting one of the plurality of stocking plans that best satisfies the business objective.
